(19) United States
(12) Patent Application Publication
(10) Pub. No.: US 2024/0360335 A1
(43) Pub. Date: Oct. 31, 2024

(54) EPOXY RESIN COMPOSITIONS, COMPOSITE MATERIALS, AND METHODS OF COATING SUBSTRATES

(71) Applicant: Westlake Epoxy Inc., Houston, TX (US)

(72) Inventors: Christoph SCHEUER, Dinslaken (DE); Gabriele BADINI, Dusseldorf (DE); Alexander LINZNER, Bottrop (DE); Thomas DRESSEN, Xanten (DE)

(21) Appl. No.: 18/140,335

(22) Filed: Apr. 27, 2023

(51) Int. Cl. C09D 163/00; C08G 59/66; H02K 1/04; H02K 15/12

(52) U.S. Cl. CPC C09D 163/00; C08G 59/66; H02K 1/04; H02K 15/12

(57) ABSTRACT

Embodiments of the present disclosure generally relate to epoxy resin compositions, composite materials comprising such compositions, coated substrates or articles comprising such compositions, and methods of coating substrates. In an embodiment, an article includes a substrate and a material disposed on the surface of the substrate. The material includes a coupling agent and an epoxy resin composition. In another embodiment, a method of coating a component of an electric motor is provided. The method includes introducing a coupling agent with a surface of a substrate; depositing an epoxy resin composition on the coupling agent; and curing the coupling agent and the epoxy resin composition to form a material disposed on the surface of the substrate.

### FIELD

Embodiments of the present disclosure generally relate to epoxy resin compositions, composite materials comprising such compositions, coated substrates comprising such compositions, and methods of coating substrates.

### BACKGROUND

Interest in synchronous reluctance motors for use in electric and hybrid vehicles has increased as manufacturers focus on rare-earth free, or low rare-earth content, electric motor technologies, such as synchronous reluctance motors and permanent magnet assisted reluctance (PMAR) motors. Synchronous reluctance motors include an outer stationary stator and an inner rotor, separated by a small air gap, and interact magnetically to produce output torque. As an alternative to induction motors which experience a discrepancy between the oscillating alternating current (AC) frequency input and the rotational frequency output, and therefore cannot be used for precisely-timed application, synchronous reluctance motors are characterized as having the rotational frequency output equal the AC frequency input. One aspect in the design of synchronous reluctance motors is that the rotor should carry mechanical loads without failure. Traditional approaches to mechanically reinforce rotors have included adding bridges and posts to the lamination to connect electrical steel layers. However, bridges and posts are a source of magnetic flux leakage resulting in reduced power, torque and efficiency of the motor. Although several techniques to mechanically reinforce the rotor are known, such as the use of bi-phase magnetic materials, anchoring shafts, or reinforcement wraps, such techniques have varying degrees of effectiveness. For example, each of these techniques have manufacturing and cost challenges, and the use of reinforcement wraps, as an example, detrimentally increases the air gap between the stator and rotor.

Composite materials, such as polymer composites, have also been used. Here, polymer composites are typically inserted into air-filled slots of the rotor and structurally bind to the electrical steel. Such composites, however can suffer from insufficient bond strength (for example, adhesion) between the electrical steel and the composite. Traditional composite materials can also be challenged by their inability to withstand high thermal stresses. Here, composite materials used to stabilize rotor core designs for high reluctance torque should be able to withstand high thermal stresses due to the large range of temperature exposures from about −40° C. to about 180° C. and high centrifugal forces caused by the high rotational speeds. The mismatch in thermal expansion (CTE) between conventional potting materials and the core material of the motors (electrical steel, grain-oriented sheets, and blades) causes cracking of the composite potting materials.

Therefore, there is a need for new and improved epoxy resin compositions and composite materials comprising epoxy resin compositions. There is also a need for improved methods of coating substrates.

### SUMMARY

Embodiments of the present disclosure generally relate to epoxy resin compositions, composite materials thereof, coated substrates thereof, and methods of coating substrates. Relative to conventional compositions, embodiments of epoxy resin compositions described herein (or composite materials thereof) can show, for example, improved resistance to cracking under thermal stress, mechanical stress, among other damaging or degrading forces. In addition, and in contrast to conventional technologies, embodiments described herein can enable improved adhesion between an epoxy resin composition and a substrate by use of, for example, a coupling agent. Embodiments described herein can be used in a variety of applications including, for example, electric motors, such as synchronous reluctance motors and PMAR motors, among other applications.

In an embodiment, an article is provided. The article includes a substrate and a material disposed on the surface of the substrate, the material comprising a coupling agent and an epoxy resin composition.

In another embodiment, an article is provided. The article includes a metal substrate and a material disposed the metal substrate, the material comprising: a coupling agent disposed on a surface of the metal substrate; and an epoxy resin composition disposed on the coupling agent. The epoxy resin composition includes an epoxy resin, a polyhydric alcohol, a curing agent for curing the epoxy resin, and a polycaprolactone-polysiloxane block copolymer.

In another embodiment, an electric motor component is provided. The electric motor component includes a metal substrate, and a composite material disposed on the metal substrate. The composite material includes a reaction product of a coupling agent, and an epoxy resin composition. The epoxy resin composition includes an epoxy resin, a polyhydric alcohol, a curing agent for curing the epoxy resin, and a polycaprolactone-polysiloxane block copolymer.

In another embodiment, a method of coating a substrate is provided. The method includes introducing a coupling agent with a surface of a substrate; and depositing the epoxy resin composition on the coupling agent. The method further includes curing the coupling agent and the epoxy resin composition to form a composite material disposed on the surface of the substrate.

In another embodiment, a method of coating a substrate is provided. The method includes introducing a coupling agent with a surface of a substrate; depositing the epoxy resin composition on the coupling agent; curing the coupling agent and the epoxy resin composition to form a composite material disposed on the surface of the substrate, the composite material comprising the coupling agent, the epoxy resin composition, a reaction product thereof, or combinations thereof.

In another embodiment, a method of coating a component of an electric motor is provided. The method includes introducing a coupling agent with a surface of a component of an electric motor; depositing an epoxy resin composition on the coupling agent; and curing the coupling agent and the epoxy resin composition to form a composite material disposed on the surface of the component of the electric motor, the composite material comprising the coupling agent, the epoxy resin composition, a reaction product thereof, or combinations thereof.

In another embodiment, a method of forming a motor component is provided. The method includes exposing a metal substrate to a coupling agent, depositing an epoxy resin composition on the coupling agent, and curing the coupling agent and the epoxy resin composition.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, may admit to other equally effective embodiments.

FIG. 1A is a side view of a coated substrate according to at least one embodiment of the present disclosure.

FIG. 1B is a side view of a coated substrate according to at least one embodiment of the present disclosure.

FIG. 2 is a flowchart showing selected operations of a method of forming a coated substrate according to at least one embodiment of the present disclosure.

### DETAILED DESCRIPTION

Embodiments of the present disclosure generally relate to epoxy resin compositions, coated substrates comprising such compositions, and methods of coating substrates. Embodiments described herein can be used in a variety of applications including electric motors, such as synchronous reluctance motors and permanent magnet assisted reluctance (PMAR) motors, among other applications.

As described further below, a substrate surface (for example a metal surface, such as a metal surface of a component of a motor) can be treated according to embodiments described herein. Such treatment can include, for example, deposition of a layer comprising a coupling agent on the substrate surface. Epoxy resin compositions described herein can then be deposited on the layer comprising the coupling agent. The combined layers—the layer comprising the coupling agent and the layer comprising the epoxy resin composition—can be cured to form a composite material. Composite materials described herein can have improved properties relative to conventional compositions and composite materials. For example, embodiments of composite materials described herein can have an improved flexural strength relative to conventional technologies. Further, composite materials described herein can have a coefficient of thermal expansion (CTE) that better matches the CTE of the cores of motors (for example, electric steel sheets present in rotors and stator electric steel sheets) than conventional compositions. A better match in CTE results in less cracking of the composite material. In contrast, the large mismatch in CTE between conventional potting materials and the cores of motors causes cracking of the conventional potting materials.

In addition, composite materials described herein can withstand high thermal stresses, high mechanical forces, and high centrifugal forces present during operation of motors. For example, composite materials described herein can withstand high thermal stresses and high centrifugal forces caused by the high rotational speeds observed during operation of, for example, electric motors such as synchronous reluctance motors, PMAR motors, among other electric motors.

The improved properties of composite materials described herein are a result of, for example, the improved adhesion between epoxy resin compositions and the substrate surface. Here, the inventor found that, for example, treating the substrate surface prior to deposition of an epoxy resin composition provides the improved adhesion. In electric motor applications, the improved adhesion of the epoxy resin compositions with a surface of an electric motor component can support, for example, the high-speed operation of such motors.

Unlike conventional compositions and composite materials that lack sufficient adhesion between surfaces (for example, electrical steel and blades) of electric motors, embodiments described herein demonstrate sufficient bond strength/adhesion to surfaces (such as electrical steel and blades) of electric motors. Further, embodiments described herein can withstand high thermal stresses and centrifugal forces typically observed in electric motors. Compositions described herein can also be resistant to cracking.

The use of headings is for purposes of convenience only and does not limit the scope of the present disclosure. Embodiments described herein can be combined with other embodiments.

As used herein, a “composition” can include component(s) of the composition, reaction product(s) of two or more components of the composition, a remainder balance of remaining starting component(s), or combinations thereof. Compositions of the present disclosure can be prepared by any suitable mixing process.

As used herein, a “composite material” can include component(s) of the composite material, reaction product(s) of two or more components of the composite material, a remainder balance of remaining starting component(s), or combinations thereof. Composite materials of the present disclosure can be prepared by any suitable mixing process.

### Epoxy Resin Compositions

Embodiments of the present disclosure generally relate to epoxy resin compositions that can be used for various applications. For example, the epoxy resin compositions described herein can be utilized as adhesive compositions or potting materials used to stabilize, for example, electric motors, such as synchronous reluctance motors and PMAR motors, or a component thereof. The epoxy resin compositions can be used as casting compositions (reaction compositions), molding compositions (reaction resin compositions), as prepregs, among other applications. The epoxy resin compositions can be used in electrical engineering, for example for sheathing electrical and electronic components such as capacitors, collectors, and resistors. As further described below, the epoxy resin compositions can be used as part of a composite material useful in, for example, electric motor applications among other applications.

When disposed on, for example, a motor or electric motor, epoxy resin compositions described herein show less cracking under operating conditions of electric motors. Here, the epoxy resin compositions can withstand high thermal stresses and high centrifugal forces caused by high rotational speeds observed during use of electric motors such as synchronous reluctance motors and PMAR motors. That is, epoxy resin compositions described herein can support the high-speed operation of electric motors.

Epoxy resin compositions of the present disclosure can include an epoxy resin, an alcohol, a curing agent, or combinations thereof. Epoxy resin compositions can further include a block copolymer (such as a polycaprolactone-polysiloxane block copolymer), accelerators, or combinations thereof. The epoxy resin compositions can further include one or more additives such as fillers (such as inorganic fillers, low CTE fillers).

The epoxy resin compositions can be curable compositions wherein the epoxy resin compositions can be cured by application of a stimulus, for example, a change in temperature.

In some embodiments, an epoxy resin composition includes a first component, a second component, a third component, or combinations thereof.

In some embodiments, the first component includes an epoxy resin, an alcohol, optionally additives, or combinations thereof. The alcohol can be a monohydric alcohol, a polyhydric alcohol, or combinations thereof. In at least one embodiment, the first component can include from about 75 wt % to about 99.5% by weight of an epoxy resin and from about 0.5 wt % to about 25 wt % of an alcohol. A total weight percent of the first component does not exceed 100 wt %. Illustrative, but non-limiting, examples of epoxy resins, alcohols, and optional additives are discussed below. In addition, other formulations of the first component are discussed below.

In some embodiments, the second component includes a curing agent, a block copolymer, optionally an accelerator, optionally additives, or combinations thereof. The curing agent utilized is suitable for curing the epoxy resin.

In at least one embodiment, the second component can include from about 80 wt % to about 99 wt % of a curing agent which is suitable for curing the epoxy resin, and from about 1 wt % to about 20 wt % of a block copolymer (such as a polycaprolactone-polysiloxane block copolymer). A total weight percent of the second component does not exceed 100 wt %. Illustrative, but non-limiting, examples of curing agents, block copolymers, optional accelerators, and optional additives are discussed below. In addition, other formulations of the second component are discussed below.

In some embodiments, the third component includes an optional accelerator. A total weight percent of the third component does not exceed 100 wt %. Illustrative, but non-limiting, examples of optional accelerators are discussed below.

When an epoxy resin composition includes one or more of a first component, a second component, a third component, or combinations thereof, a total wt % of the epoxy resin composition does not exceed 100 wt %.

The first component can include one or more epoxy resins. Suitable epoxy resins are those compounds containing at least one vicinal epoxy group. Epoxy resins can be monomeric or polymeric. The epoxy resin may be saturated or unsaturated, aliphatic, cycloaliphatic, aromatic or heterocyclic and may be substituted. In some examples, the choice of epoxy resin is based on, for example, the UV resistance properties desired.

The epoxy resin utilized may be, for example, an epoxy resin or a combination of epoxy resins prepared from an epihalohydrin and a phenol or a phenol type compound, prepared from an epihalohydrin and an amine, prepared from an epihalohydrin and an a carboxylic acid, or prepared from the oxidation of unsaturated compounds.

Suitable epoxy resins useful for embodiments described herein can include aromatic epoxy resins and non-aromatic epoxy resins. The epoxy resins can contain more than one and in some embodiments, two 1,2-epoxy groups per molecule. In some embodiments, the epoxy resin may be liquid rather than solid. In at least one embodiment, the epoxy resin has an epoxide equivalent weight of about 100 to about 5,000, such as from about 100 to about 2,000, such as from about 100 to 500, as determined by titration methods described in ASTM D1652.

In some embodiments, the epoxy resins may be non-aromatic hydrogenated cyclohexane dimethanol and diglycidyl ethers of hydrogenated Bisphenol A-type epoxy resin, such as hydrogenated bisphenol A-epichlorohydrin epoxy resin, cyclohexane dimethanol diglycidylether, and cycloaliphatic epoxy resin.

In at least one embodiment, the epoxy resins utilized include aromatic epoxy resins such as those resins produced from an epihalohydrin and a phenol or a phenol-type compound. The phenol-type compound includes compounds having an average of more than one aromatic hydroxyl group per molecule. Examples of phenol-type compounds include dihydroxy phenols, biphenols, bisphenols, halogenated biphenols, halogenated bisphenols, hydrogenated bisphenols, alkylated biphenols, alkylated bisphenols, trisphenols, phenol-aldehyde resins, novolac resins (the reaction product of phenols and simple aldehydes, such as formaldehyde), halogenated phenol-aldehyde novolac resins, substituted phenol-aldehyde novolac resins, phenol-hydrocarbon resins, substituted phenol-hydrocarbon resins, phenol-hydroxybenzaldehyde resins, alkylated phenol-hydroxybenzaldehyde resins, hydrocarbon-phenol resins, hydrocarbon-halogenated phenol resins, hydrocarbon-alkylated phenol resins, or combinations thereof.

In some embodiments, the epoxy resin utilized can include those resins produced from an epihalohydrin and bisphenols, halogenated bisphenols, hydrogenated bisphenols, novolac resins, and polyalkylene glycols, or combinations thereof.

In at least one embodiment, the epoxy resin utilized in epoxy resin compositions of the disclosure can include those resins produced from an epihalohydrin and resorcinol, catechol, hydroquinone, biphenol, bisphenol A, bisphenol AP (1,1-bis(4-hydroxyphenyl)-1-phenyl ethane), bisphenol F, bisphenol K, tetrabromobisphenol A, phenol-formaldehyde novolac resins, alkyl substituted phenol-formaldehyde resins, phenol-hydroxybenzaldehyde resins, cresol-hydroxybenzaldehyde resins, dicyclopentadiene-phenol resins, dicyclopentadiene-substituted phenol resins tetramethylbiphenol, tetramethyl-tetrabromobiphenol, tetramethyltribromobiphenol, tetrachlorobisphenol A, or combinations thereof.

In some embodiments, the epoxy resin utilized in epoxy resin compositions of the present disclosure include those resins produced from an epihalohydrin and an amine. Suitable amines include diaminodiphenylmethane, aminophenol, xylene diamine, anilines, and the like, or combinations thereof.

In at least one embodiment, the epoxy resin utilized in epoxy resin compositions of the present disclosure can include those resins produced from an epihalohydrin and a carboxylic acid. Suitable carboxylic acids include phthalic acid, isophthalic acid, terephthalic acid, tetrahydrohydrophthalic acid, hexahydrophthalic acid, endomethylenetetrahydrophthalic acid, isophthalic acid, methylhexahydrophthalic acid, and the like or combinations thereof.

In some embodiments, the epoxy resin compounds utilized in epoxy resin compositions of the disclosure include those resins produced from an epihalohydrin and compounds having at least one aliphatic hydroxyl group. In such embodiments, it is understood that such epoxy resin compositions produced contain an average of more than one aliphatic hydroxyl groups. Examples of compounds having at least one aliphatic hydroxyl group per molecule include aliphatic alcohols, aliphatic diols, polyether diols, polyether triols, polyether tetrols, any combination thereof and the like. Also suitable are the alkylene oxide adducts of compounds containing at least one aromatic hydroxyl group. In this embodiment, it is understood that such epoxy resin compositions produced contain an average of more than one aromatic hydroxyl groups. Examples of oxide adducts of compounds containing at least one aromatic hydroxyl group per molecule include ethylene oxide, propylene oxide, or butylene oxide adducts of dihydroxy phenols, biphenols, bisphenols, halogenated bisphenols, alkylated bisphenols, trisphenols, phenol-aldehyde novolac resins, halogenated phenol-aldehyde novolac resins, alkylated phenol-aldehyde novolac resins, hydrocarbon-phenol resins, hydrocarbon-halogenated phenol resins, or hydrocarbon-alkylated phenol resins, or combinations thereof.

The epoxy resin, in some embodiments, can refer to an advanced epoxy resin which is the reaction product of one or more epoxy resins components, as described above, with one or more phenol type compounds and/or one or more compounds having an average of more than one aliphatic hydroxyl group per molecule as described above. Alternatively, the epoxy resin may be reacted with a carboxyl substituted hydrocarbon. A carboxyl substituted hydrocarbon is described herein as a compound having a hydrocarbon backbone, such as a C₁-C₄₀ hydrocarbon backbone, and one or more carboxyl moieties, such as more than one, such as two. The C₁-C₄₀ hydrocarbon backbone may be a linear alkane, branched alkane, linear alkene, branched alkene, optionally containing oxygen. Fatty acids and fatty acid dimers are among the useful carboxylic acid substituted hydrocarbons. Included in the fatty acids are caproic acid, caprylic acid, capric acid, octanoic acid, pivalic acid, neodecanoic acid, decanoic acid, lauric acid, myristic acid, palmitic acid, stearic acid, palmitoleic acid, oleic acid, linoleic acid, linolenic acid, erucic acid, pentadecanoic acid, margaric acid, arachidic acid, and dimers thereof.

In at least one embodiment, the epoxy resin is a reaction product of a polyepoxide and a compound containing more than one isocyanate moiety or a polyisocyanate. The epoxy resin produced in such a reaction can be an epoxy-terminated polyoxazolidone.

In some embodiments, the epoxy resin includes cyclohexanol, 4,4′-(1-methylethylidene)bis-, polymer with 2-(chloromethyl)oxirane (CAS Number 30583-72-3).

In at least one embodiment, the epoxy resin can be selected from the group consisting of a difunctional bisphenol-A-diglycidyl-ether, a bisphenol-F-diglycidyl-ether, a tetraglycidyl-methylenedianiline (TGMDA), an epoxidized tetra-phenylethane, a derivative thereof, and combinations thereof. In some embodiments, the epoxy resin can be derived from a compound selected from the group consisting of bisphenol A, bisphenol F, tetraglycidyl-methylenedianiline, a terephthalic acid, a phthalic acid, a hexahydrophthalic acid, a halogenated bisphenol, a novolac, an ortho-aminophenol, a para-aminophenol, a flourenone bisphenol, a dicyclopentadiene, and combinations thereof.

Examples of epoxy resins include epoxy resins of dihydroxy phenols, epoxy resins of biphenols, epoxy resins of bisphenols, epoxy resins of halogenated bisphenols, epoxy resins of alkylated bisphenols, epoxy resins of trisphenols, epoxy resins of phenol-aldehyde novolac resins, epoxy resins of halogenated phenol-aldehyde novolac resins, epoxy resins of alkylated phenol-aldehyde novolac resins, epoxy resins of hydrocarbon-phenol resins, epoxy resins of hydrocarbon-halogenated phenol resins, epoxy resins of hydrocarbon-alkylated phenol resins, or combinations thereof. Illustrative, but non-limiting, examples of an epoxy resins include Epikote Resin 05570 (epoxy resin based on bisphenol A and mineral fillers) and Epikote Resin 858 (an epoxy resin based on bisphenol A and mineral fillers).

Other illustrative, but non-limiting, examples of epoxy resins include Epikote 828LVEL epoxy resin (a difunctional bisphenol-A-diglycidyl-ether commercially available from Westlake Epoxy), Epikote 162 epoxy resin (a bisphenol-F-diglycidyl-ether commercially available from Westlake Epoxy), Epikote 158 epoxy resin (a bisphenol-F-diglycidyl-ether commercially available from Westlake Epoxy), Epikote 496 epoxy resin (a tetra-glycidyl-methylene-dianiline commercially available from Westlake Epoxy), Epikote 1031 epoxy resin (an epoxidized tetra-phenylethane commercially available from Westlake Epoxy).

Combinations or blends, in any suitable proportions, of an epoxy resin can be utilized for embodiments described herein.

In some embodiments, a total amount of epoxy resin(s) in the first component can be from about 75 wt % to about 100 wt %, such as from about 75 wt % to about 99.5 wt %, such as from about 80 wt % to about 95 wt %, about from 85 wt % to about 90 wt %, or from about 95 wt % to about 99.5% wt %, based on a total weight of the first component. In at least one embodiment, a total amount (wt %) of epoxy resin in the first component, based on the total wt % of the first component, can be 75, 76, 77, 78, 79, 80, 81, 82, 83, 84, 85, 86, 87, 88, 89, 90, 31, 92, 93, 94, 95, 96, 97, 98, 99, 99.5, or 100, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other amounts of epoxy resin(s) are contemplated.

The first component can also include one or more alcohols. Alcohols include monohydric alcohols, polyhydric alcohols (also called polyols), or combinations thereof. Suitable polyols include, but are not limited to glycols (dihydric alcohols (diols)) which can be derived from ethylene glycol, such as, for example, ethylene glycol, propylene glycol, methyl glycol, trimethylene glycol, neopentyl glycol, diethylene glycol, triethylene glycol, polyethylene glycol, polypropylene glycol, sugar compounds or combinations thereof. Trivalent or higher valent alcohols can also be used, such as, for example, glycerol, trimethylolpropane, glucose, other sugar compounds, or combinations thereof. Other alcohols and polyols are contemplated. In some examples, epoxy resin compositions described herein include a polyol such as glycols, such as ethylene glycol, propylene glycol, polyethylene glycol, polypropylene glycol, glycerols, a sugar compound, or combinations thereof. A non-limiting example of a glycol can include Heloxy PF, which is propylene glycol with a weight average molecular weight (Mw) of 400 g/mol. However, trivalent or higher valent alcohols can also be used, such as, for example, glycerol, trimethylolpropane, glucose, other sugar compounds, or combinations thereof.

In some embodiments, a total amount of alcohol(s) in the first component can be from about 0 wt % to about 25 wt %, such as from about 0.5 wt % to about 25 wt %, such as from about 1 wt % to about 20 wt %, such as from about 5 wt % to about 15 wt %, based on a total weight of the first component. In at least one embodiment, a total amount of alcohol, polyol, or combinations thereof in the first component can be from about 0.5 wt % to about 3 wt %, such as from about 1 wt % to about 2.5 wt %, such as from about 1.5 wt % to about 2 wt %, based on the total weight of the first component. In at least one embodiment, a total amount (wt %) of alcohol(s) in the first component, based on the total wt % of the first component, can be 0, 0.5, 1, 1.5, 2, 2.5, 3, 4, 5, 6, 7, 8, 9, 10, 11, 12, 13, 14, 15, 16, 17, 18, 19, 20, 21, 22, 23, 24, or 25, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other amounts are contemplated.

In some non-limiting examples, it was found that a lower wt % (such as about 10 wt % or less) of alcohol(s) in the first component can be advantageous in various applications. As a non-limiting example, a balanced relationship between the improvement in the fracture toughness and an acceptable glass transition temperature can be achieved in a concentration range of about 10 wt % of alcohol(s) or less in the first component.

The first component can optionally include additives. The optional additives can include processing aids (for example, anti-foam agents air-release agents, silanes or combinations thereof), pigments, or combinations thereof. In some embodiments, a total amount of additives in the first component can be from about 0 wt % to about 10 wt %, such as such as from about 0.05 wt % to about 10 wt %, such as from about 0.1 wt % to about 9 wt %, such as from about 0.5 wt % to about 8 wt %, such as from about 1 wt % to about 5 wt %, based on a total weight of the first component. In at least one embodiment, a total amount (in wt %) of optional additive(s) in the first component, based on the total wt % of the first component, can be 0, 0.01, 0.03, 0.05, 0.1, 0.25, 0.5, 0.75, 1, 1.5, 2, 2.5, 3, 3.5, 4, 4.5, 5, 5.5, 6, 6.5, 7, 7.5, 8, 8.5, 9, 9.5, or 10, or ranges thereof, though other amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

Illustrative, but non-limiting, examples of anti-foam agents can include FC-402 (which includes tall oil fatty acids, glycols, and Si-containing materials, and is commercially available from Enterprise Specialty Products); Byk-037 (a volatiles-free, silicone-containing anti-foam agent commercially available from BYK-Chemie GmbH); Surfynol 104H (a multifunctional surfactant commercially available from Evonik Industries AG), or combinations thereof. In some embodiments, a total amount of anti-settling agent(s) in the first component can be from about 0 wt % to about 10 wt %, such as from about 0.05 wt % to about 8 wt %, such as from about 0.05 wt % to about 2 wt %, based on the total weight of the first component. Any of the foregoing numbers can be preceded by the word “about,” “at least about,” “less than about,” or “more than about,” and any of the foregoing numbers can be used singly to describe an open-ended range or in combination to describe a close-ended range. Other amounts are contemplated.

Air-release agents can reduce the amount of bubbling in epoxy resin compositions (for example, to remove gaseous impurities). Illustrative, but non-limiting, examples of air-release agents include Byk 5732, Byk-A 500, Byk-A 50, Byk-A 515, Byk 390, Byk 306, Byk 315, and Byk 356, each of which are commercially available from BYK-Chemie GmbH. Combinations of anti-settling agents can be used. In some embodiments, a total amount of air-release agent(s) in the first component can be from about 0 wt % to about 10 wt %, such as from about 0.05 wt % to about 8 wt %, such as from about 0.05 wt % to about 2 wt %, based on the total weight of the first component. Any of the foregoing numbers can be preceded by the word “about,” “at least about,” “less than about,” or “more than about,” and any of the foregoing numbers can be used singly to describe an open-ended range or in combination to describe a close-ended range. Other amounts are contemplated.

As mentioned above, the second component can include a curing agent that is suitable for curing the epoxy resin. Suitable curing agents can include a phenol, an imidazole, a thiol, an imidazole complex, a carboxylic acid, a boron trihalide, a novolak, a melamine-formaldehyde resin, an anhydride, or combinations thereof. In some embodiments, anhydride curing agents include dicarboxylic anhydrides, tetracarboxylic anhydrides, combinations thereof, or modifications thereof Δs non-limiting examples, anhydrides include tetrahydrophthalic anhydride (THPA), hexahydrophthalic anhydride (HHPA), methyltetrahydrophthalic anhydride (MTHPA), methylhexahydrophthalic anhydride (MHIHPA), methylnadic anhydride (MNA), dodecenylsuccinic anhydride (DBA), or combinations thereof. As modified dicarboxylic anhydrides, there can be used acid esters (reaction products of above-mentioned anhydrides or mixtures thereof with diols or polyols, for example: neopentyl glycol (NPG), polypropylene glycol (PPG, such as those having a weight average molecular weight that is from about 200 g/mol to about 1000 g/mol).

Other non-limiting examples of curing agents include amine curing agents or amine-type curing agents, such as a polyamine (which can be aliphatic, cycloaliphatic, aromatic, or combinations thereof), a polyamide, a Mannich base, a polyaminoimidazoline, a polyetheramine, or combinations thereof. Examples include, but are not limited to, Jeffamine D230 (Huntsman Advance Materials LLC.), Jeffamine D400 (Huntsman Advance Materials LLC.), or combinations thereof, the use of which can result in curing with low exothermy. Polyamines, such as, for example, isophoronediamine, can impart a high glass transition (TG) value to the epoxy resin composition. Mannich bases, such as, for example, Epikure 110 (Hexion Inc.) can show low carbamate formation and high reactivity.

Illustrative, but non-limiting, examples of curing agents include Epikure 05556 (a modified acid anhydride containing mineral filler-type curing agent), Epikure 859/1 (a modified acid anhydride containing mineral filler-type curing agent).

The curing agent can be a catalytic curing agent, such as a latent catalytic curing agent, a catalytic curing agent that is not latent, or combinations thereof. Latent catalytic curing agents become active in response to temperatures above ambient temperatures, as further described below. Catalytic curing agents that are not latent can, for example, initiate cure at ambient temperatures. Latent catalytic curing agents can allow for control over the onset of polymerization and simplified operation. For example, use of latent catalysts avoids in-situ addition of chemicals that may be highly reactive and mixing problems. Latent catalysts can be stored together without premature reaction, thereby enabling the use of single component formulations that are ready to polymerize by application of an appropriate stimulus.

When a curing agent is described as being “active” at a selected temperature or temperature range, the term “active” refers to the curing agent causing reactions (for example, polyadditions) to occur between one or more components of the epoxy resin composition when the temperature is set to the selected temperature or temperature range.

The stimulant, such as heat, acts on materials of the epoxy resin composition (for example, the latent catalytic curing agent). Upon application of the stimulus, the latent catalytic curing agent causes polyaddition reactions to occur and resulting in coupling, cross-linking, or both, of the epoxy resin among other materials.

Suitable latent catalytic curing agents (also called “latent catalysts”) can include an imidazole, a substituted imidazole, an imidazole adduct, an imidazole complex (for example, Ni-imidazole complex), a tertiary amine, a quaternary ammonium compound, a quaternary phosphonium compound, a dicyandiamide, a salicylic acid, urea, a urea derivative, a boron trifluoride complex, a boron trichloride complex (for example, boron trichloride alkylalmine complex, an epoxy addition reaction product, a tetraphenylene-boron complex, an amine borate, a metal halide, an amine titanate, a metal acetylacetonate, a naphthenic acid metal salt, an octanoic acid metal salt, other metal salts, metal chelates, or combinations thereof. Latent catalytic curing agents can include, for example, boron trichloride dimethyloctylamine complex (CAS No. 34762-90-8), oligomeric polyethylenepiperazines, bis-(dimethylaminopropyl)-amino-2-propanol, N,N′-bis-(3-dimethylaminopropyl)urea, N-(2-hydroxypropyl)imidazole, dimethyl-2-(2-aminoethoxy)ethanol, bis(2-dimethylaminoethyl) ether, pentamethyldiethylenetriamine, dimorpholinodiethyl ether, 1,8-diazobicyclo[5.4.0]undec-7-ene (DBU) (CAS No. 6674-22-2), N-methylimidazole (also known as 1-methylimidazole (CAS No. 616-47-7)), 1,2-dimethylimidazole, triethylenediamine, 1,1,3,3-tetra-methylguanidine, tin(IV) chloride, tin octoate, or combinations thereof.

In some embodiments, a total amount of curing agent(s) in the second component can be from about 80 wt % to about 100 wt %, such as from about 80 wt % to about 99 wt %, such as from about 85 wt % to about 95 wt %, from about 90 wt % to about 95 wt %, or from about 90 wt % to about 99 wt %, based on a total weight of the second component. In at least one embodiment, a total amount (wt %) of curing agent(s) in the second component, based on the total wt % of the second component, can be 80, 81, 82, 83, 84, 85, 86, 87, 88, 89, 90, 31, 92, 93, 94, 95, 96, 97, 98, 99, 99.5, or 100, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other amounts are contemplated.

In some non-limiting examples, it was found that a higher wt % (such as from about 90 wt % to about 99 wt %) of the curing agent can be advantageous in various applications because of, for example, its influence on the viscosity of the second component.

The amount of the curing agent utilized in epoxy resin compositions described herein is usually governed by the epoxide equivalent (amount of resin, in grams, containing 1 mol of epoxide group) of the epoxy resin used and of the curing agent used.

The second component can further include any suitable block copolymer such as a polycaprolactone-polysiloxane block copolymer. Examples of suitable block copolymers are described in, for example, U.S. Pat. No. 4,663,413 and EP 2352793 B1.

In some embodiments, a block copolymer than can be utilized with embodiments described herein is a A″-B-A′ block copolymer. The A″-B-A′ block copolymer can be represented by formula (I):

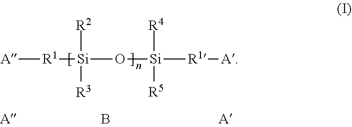

The A″-B-A′ block copolymer includes an organosiloxane block B and a polylactone block A″ or A′. The A″-B-A′ block copolymer may be linear or branched, cyclic or acyclic.

In formula (I), n can be an integer that is from about 1 to about 200, such as from about 10 to about 180, such as from about 20 to about 150, such as from about 30 to about 120, such as from about 40 to about 100, such as from about 50 to about 80, though other values for n are contemplated. Any of the foregoing numbers can be used singly to describe an open-ended range or in combination to describe a close-ended range.

Each of R^{1′} and R¹ of formula (I) can be, independently, an alkylether or an alkylamine, the alkylether or alkylamine having from 1 to 10 carbon atoms, such as from 1 to 7 carbon atoms, such as 2 to 6 carbon atoms, such as 3 to 5 carbon atoms, though other values are contemplated. Any of the foregoing numbers can be used singly to describe an open-ended range or in combination to describe a close-ended range. The alkylether and the alkylamine may be linear or branched, saturated or unsaturated, cyclic or acyclic, aromatic or not aromatic. Regarding saturation, each of R^{1′} and R¹ of formula (I) can be, independently, fully saturated, partially unsaturated, or fully unsaturated.

Each of R², R³, R⁴, and R⁵ of formula (I) can be, independently, an unsubstituted hydrocarbyl or a substituted hydrocarbyl. Each of R², R³, R⁴, and R⁵ may be linear or branched, saturated or unsaturated, cyclic or acyclic, aromatic or not aromatic. Regarding saturation, each of R², R³, R⁴, and R⁵ of formula (I) can be, independently, fully saturated, partially unsaturated, or fully unsaturated. In some embodiments, each of R², R³, R⁴, and R⁵ of formula (I) can have, independently, any suitable number of carbon atoms, such as from 1 to 20 carbon atoms, such as from 1 to 10 carbon atoms, such as from 1 to 5 carbon atoms, such as from 1 to 4 carbon atoms, though other values are contemplated. Any of the foregoing numbers can be used singly to describe an open-ended range or in combination to describe a close-ended range.

An “unsubstituted hydrocarbyl” refers to a group that consists of hydrogen and carbon atoms only. Non-limiting examples of unsubstituted hydrocarbyl include an alkyl group having from 1 to 20 carbon atoms such as methyl, ethyl, n-propyl, isopropyl, n-butyl, iso-butyl, sec-butyl, and tert-butyl, pentyl, hexyl, heptyl, octyl, ethyl-2-hexyl, isooctyl, nonyl, n-decyl, isodecyl, or isomers thereof; a cycloaliphatic group having from 3 to 20 carbon atoms such as, for example, cyclopentyl or cyclohexyl; an aromatic group having from 6 to 20 carbon atoms such as, for example, phenyl or naphthyl; or any combination thereof.

In some embodiments, each of R², R³, R⁴, or R⁵ of formula (I) can be, independently, a substituted hydrocarbyl. A “substituted hydrocarbyl” refers to an unsubstituted hydrocarbyl in which at least one hydrogen of the unsubstituted hydrocarbyl has been substituted with at least one heteroatom or heteroatom-containing group, such as one or more elements from Group 13-17 of the periodic table of the elements, such as halogen (F, Cl, Br, or I), O, N, Se, Te, P, As, Sb, S, B, Si, Ge, Sn, Pb, and the like, such as C(O)R*, C(C)NR*₂, C(O)OR*, NR*₂OR*, SeR*, TeR*, PR*₂, AsR*₂, SbR*₂, SR*, SOₓ (where x=2 or 3), BR*₂, SiR*₃, GeR*₃, SnR*₃, PbR*₃, and the like, where R* is, independently, hydrogen or unsubstituted hydrocarbyl, or where at least one heteroatom has been inserted within the unsubstituted hydrocarbyl.

In some embodiments, each of R², R³, R⁴, or R⁵ of formula (I) can be, independently, linear or branched alkyl, linear or branched alkenyl, linear or branched haloalkyl, linear or branched haloalkenyl having 6 carbon atoms or less; aryl having from 5 to 7 carbon atoms, or arylalkyl having from 6 to 8 carbon atoms.

As used herein, “alkyl” refers to a saturated hydrocarbyl and “alkenyl” refers to a hydrocarbyl having at least one double bond.

As used herein, “haloalkyl” refers to a substituted hydrocarbyl where at least one hydrogen is substituted with a halogen substituent (up to perhaloalkyl, in which every hydrogen atom of the alkyl group has been replaced by a halogen atom). As used herein, “haloalkenyl” refers to an alkenyl, as defined above, that is substituted with a halogen substituent (up to perhaloalkenyl, in which every hydrogen atom of the alkenyl group has been replaced by a halogen atom). The halogen substituent of a haloalkyl or a haloalkenyl can be F, Cl, Br, or I. Combinations of halogen substituents (for example, F and Cl) can be in a haloalkyl or a haloalkenyl.

As used herein, “aryl” refers to an unsubstituted or substituted aromatic ring. As used herein, “arylalkyl” refers to a group of the formula —R^{b}—R^{c}, where R^{b} is an alkylene (a straight or branched divalent hydrocarbon) and R^{c} is one or more aryls as defined above, for example, benzyl, diphenylmethyl, and the like.

Each of A′ and A″ of formula (I) can be, independently, represented by formula (II):

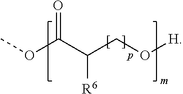

In formula (II), m can be an integer such as from 1 to 25, such as from 2 to 22, such as from 5 to 20, such as from 10 to 15, though other integers are contemplated. Any of the foregoing numbers can be used singly to describe an open-ended range or in combination to describe a close-ended range.

In formula (II), p can be an integer from 1 to 6, such as from 2 to 5, such as from 3 to 4, or 1, 2, 3, 4, 5, or 6, though other integers are contemplated. Any of the foregoing numbers can be used singly to describe an open-ended range or in combination to describe a close-ended range.

R⁶ of formula (II) can be a hydrogen, an unsubstituted hydrocarbyl, or a substituted hydrocarbyl, such as those unsubstituted hydrocarbyls and substituted hydrocarbyls described above. In some embodiments, R⁶ of formula (II) can be linear or branched. In at least one embodiment, R⁶ of formula (II) is a linear alkyl group or a branched alkyl group. When R⁶ is a linear alkyl group or branched alkyl group, the linear alkyl group or branched alkyl group can have any suitable number of carbon atoms, such as from 1 to 20 carbon atoms, such as from 1 to 15 carbon atoms, such as from 1 to 12 carbon atoms, from 1 to 10 carbon atoms, such as from 1 to 6 carbon atoms, such as from 2 to 5, such as from 3 to 4, or 1, 2, 3, 4, 5, 6, 7, 8, 9, 10, 11, 12, 13, 14, 15, 16, 17, 18, 19, or 20 carbon atoms, or ranges thereof, though other numbers of carbon atoms are contemplated. Any of the foregoing numbers can be used singly to describe an open-ended range or in combination to describe a close-ended range.

An illustrative, but non-limiting, example of an A″-B-A′ block copolymer that can be used with embodiments described herein is represented by formula (III):

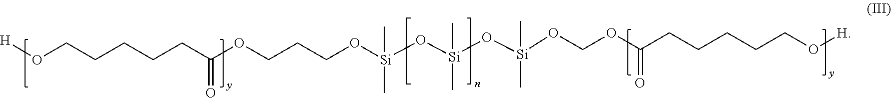

In formula (III), n can be an integer that is 1 or more, such as from about 1 to about 200, such as from about 10 to about 180, such as from about 20 to about 150, such as from about 30 to about 120, such as from about 40 to about 100, such as from about 50 to about 80, though other values are contemplated. Any of the foregoing numbers can be used singly to describe an open-ended range or in combination to describe a close-ended range. In formula (III), each y can be, independently, an integer that is 1 or more, such as 2 or more, such as 3 or more, such as from 3 to 10, such as from 3 to 6, or 1, 2, 3, 4, 5, 6, 7, 8, 9, or 10, or ranges thereof.

In some embodiments, a total amount of block copolymer(s) (for example, a total amount of polycaprolactone-polysiloxane block copolymer(s)) in the second component can be greater than 0 wt %, about 25 wt % or less, or combinations thereof, such as from about 0.5 wt % to about 22 wt %, such as from about 1 wt % to about 20 wt %, such as from about 1 wt % to about 10 wt %, about 5 wt % to about 15 wt %, or from about 5 wt % to about 19 wt %, based on the total weight of the second component. In at least one embodiment, a total amount (wt %) of block copolymer(s) (for example, a total amount of polycaprolactone-polysiloxane block copolymer(s)) in the second component, based on the total wt % of the second component, can be 0.05, 0.1, 0.5, 1, 1.5, 2, 2.5, 3, 4, 5, 6, 7, 8, 9, 10, 11, 12, 13, 14, 15, 16, 17, 18, 19, 20, 21, 22, 23, 24, or 25, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other amounts are contemplated. In some non-limiting examples, it was found that a lower wt % (such as from about 1 wt % to about 10 wt %) of the polycaprolactone-polysiloxane block copolymer can be advantageous for achieving efficiency of mixing at suitable viscosity. Concentrations of about 20 wt % or more may lead to increases in the processing viscosity.

The second component can optionally include an accelerator. Accelerators include, but are not limited to, an imidazole, a substituted imidazole, an imidazole adduct, an imidazole complex (for example, a Ni-imidazole complex), a tertiary amine, a quaternary ammonium, a phosphonium compound, tin(IV) chloride, dicyandiamide, salicylic acid, urea, a urea derivative, a boron trifluoride complex, a boron trichloride complex, an epoxy addition reaction product, a tetraphenylene-boron complex, an amine borate, an amine titanate, a metal acetylacetonate, a naphthenic acid metal salt, an octanoic acid metal salt, a tin octoate, a further metal salt, a metal chelate, or combinations thereof. Other illustrative, but non-limiting, examples, of accelerators can include an oligomeric polyethylenepiperazine, dimethylamino-propyldipropanolamine, bis-(dimethylaminopropyl)-amino-2-propanol, N,N′-bis-(3-dimethylaminopropyl)urea, N-(2-hydroxypropyl)imidazole, dimethyl-2-(2-aminoethoxy)ethanol, bis(2-dimethylaminoethyl) ether, pentamethyldiethylenetriamine, dimorpholinodiethyl ether, 1,8-diazabicyclo[5.4.0]undec-7-ene, N-methylimidazole, 1,2-dimethylimidazole, triethylenediamine, 1,1,3,3-tetra-methylguanidine, or combinations thereof. More than one accelerator can be used in suitable proportions.

In some embodiments, a total amount of accelerator(s) in the second component can be 0 wt % or more, about 5 wt % or less, or combinations thereof, such as from about 0.5 wt % to about 3 wt %, such as from about 1 wt % to about 2 wt %, from about 0.5 wt % to about 1 wt %, or from about 1 wt % to about 1.5 wt %, based on the total weight of the second component.

In at least one embodiment, a total amount (wt %) of accelerator(s) in the second component, based on the total wt % of the second component, can be 0, 0.05, 0.1, 0.5, 1, 1.5, 2, 2.5, 3, 3.5, 4, 4.5, or 5, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other amounts are contemplated.

In some embodiments, the accelerator can be added to the second component, added separately as the third component, or combinations thereof. The addition thereof can, however, also be omitted completely from the epoxy resin composition according to some embodiments.

### Second Component—Optional Additives

The second component can optionally include additives. The optional additives can include processing aids (for example, anti-foam agents air-release agents, or both), pigments, or combinations thereof. In some embodiments, a total amount of additives in the second component can be from about 0 wt % to about 10 wt %, such as such as from about 0.05 wt % to about 10 wt %, such as from about 0.1 wt % to about 9 wt %, such as from about 0.5 wt % to about 8 wt %, such as from about 1 wt % to about 5 wt %, based on a total weight of the second component. In at least one embodiment, a total amount (in wt %) of optional additive(s) in the second component, based on the total wt % of the second component, can be 0, 0.01, 0.03, 0.05, 0.1, 0.25, 0.5, 0.75, 1, 1.5, 2, 2.5, 3, 3.5, 4, 4.5, 5, 5.5, 6, 6.5, 7, 7.5, 8, 8.5, 9, 9.5, or 10, or ranges thereof, though other amounts are contemplated. Each of the foregoing numbers can be preceded by the word “about,” “at least about,” “less than about,” or “more than about,” and any of the foregoing numbers can be used singly to describe an open-ended range or in combination to describe a close-ended range.

The ratio of the first and second components is determined on the epoxide equivalent of the epoxy resin and the equivalent mass of the curing agent used. The second component includes the curing agent and the first component includes the epoxy resin.

For example, when an anhydride curing agent is used, such as from about 70 parts to about 100 parts by weight of the second component are added per 100 parts by weight of the first component, such as from about 75 parts to about 95 parts by weight of the second component are added per 100 parts by weight of the first component, such as from about 80 parts to about 90 parts by weight of the second component are added per 100 parts by weight of the first component, though other ratios are contemplated. In at least one embodiment, and when an anhydride curing agent is used, the amount (in parts by weight) of second component to 100 parts by weight first component can be 70, 71, 72, 73, 74, 75, 76, 77, 78, 79, 80, 81, 82, 83, 84, 85, 86, 87, 88, 89, 90, 31, 92, 93, 94, 95, 96, 97, 98, 99, or 100, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other amounts of second component relative to the first component are contemplated when an anhydride curing agent is utilized.

As another example, when an amine curing agent is used, the ratio can be different. For example, and when an amine curing agent is used, the ratio can be from about 10 parts to about 30 parts by weight of the second component are added per 100 parts by weight of the first component, such as from about 15 parts to about 25 parts by weight of the second component are added per 100 parts by weight of the first component, though other ratios are contemplated. In at least one embodiment, and when an amine curing agent is used, the amount (in parts by weight) of second component to 100 parts by weight first component can be 10, 11, 12, 13, 14, 15, 16, 17, 18, 19, 20, 21, 22, 23, 24, 25, 26, 27, 28, 29, or 30, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other amounts of second component relative to the first component are contemplated when an amine curing agent is utilized.

In some embodiments, from about 5 parts to about 100 parts by weight of the second component can be added per 100 parts by weight of the first component, such as from about 10 parts to about 90 parts by weight of the second component are added per 100 parts by weight of the first component, such as from about 20 parts to about 80 parts by weight of the second component are added per 100 parts by weight of the first component, such as from about 30 parts to about 70 parts by weight of the second component are added per 100 parts by weight of the first component, such as from about 40 parts to about 60 parts by weight of the second component are added per 100 parts by weight of the first component, though other ratios are contemplated. In at least one embodiment, the amount (in parts by weight) of second component to 100 parts by weight first component can be 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 31, 92, 93, 94, 95, 96, 97, 98, 99, or 100, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other amounts of second component relative to the first component are contemplated depending on, for example, the curing agent.

When a third component is utilized in epoxy resin compositions described herein, from about 1 part to about 100 parts by weight of the third component can be added per 100 parts by weight of the first component, such as from about 10 parts to about 90 parts by weight of the third component are added per 100 parts by weight of the first component, such as from about 20 parts to about 80 parts by weight of the third component are added per 100 parts by weight of the first component, such as from about 30 parts to about 70 parts by weight of the third component are added per 100 parts by weight of the first component, such as from about 40 parts to about 60 parts by weight of the third component are added per 100 parts by weight of the first component, though other ratios are contemplated. In at least one embodiment, the amount (in parts by weight) of third component to 100 parts by weight first component can be 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 31, 92, 93, 94, 95, 96, 97, 98, 99, or 100, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other amounts of third component relative to the first component are contemplated depending on, for example, the accelerator.

The first component, second component, the third component, or combinations thereof can include fillers, adhesion-promoting additives (referred to herein as coupling agents), or combinations thereof.

Adhesion promoting additives include one or more coupling agents described herein, such as Silquest A-187 epoxy silane coupling agent, among other coupling agents. The adhesion promoting additive can support adhesion of the epoxy resin composition to a substrate.

Fillers can help improve, for example, the crack resistance of epoxy resin compositions described herein. Illustrative, but non-limiting examples of fillers include silica, fused silica wollastonite (CaSiO₃ that may contain small amounts of iron, magnesium, and manganese), quartz, alumina, aluminum nitride (AlN), boron nitride (BN), silicon nitride (SiN), silicon carbide (SiC), beryllium oxide (BeO), and combinations thereof. Ceramic materials, in general, can be used. Other fillers are contemplated. In some embodiments, if insulation properties can be secured, application of carbon fillers such as graphite can also be considered.

In some examples, the filler can include an epoxy-silane pre-treated material, such as an epoxy-silane pre-treated version of the aforementioned fillers, such as epoxy-silane pre-treated silica, epoxy-silane pre-treated wollastonite, or combinations thereof Δn illustrative, but non-limiting, example of an epoxysilane pre-treated silica filler is Millisil W12 EST commercially available from Quarzwerke Group. An illustrative, but non-limiting, example of an epoxysilane pre-treated wollastonite filler is Tremin 283-100 EST commercially available from Quarzwerke Group.

In at least one embodiment, the filler is selected from the group consisting of silica, wollastonite, quartz, alumina, aluminum nitride, boron nitride, silicon nitride, silicon carbide, beryllium oxide, epoxy-silane pre-treated silica, epoxy-silane pre-treated wollastonite, and combinations thereof.

The filler can have a low coefficient of thermal expansion. For example, and in some embodiments, the filler can have a CTE value that is from about 0.1×10⁻⁶ K⁻¹ to about 10×10⁻⁶ K⁻¹, such as from about 0.5×10⁻⁶ K⁻¹ to about 8×10⁻⁶ K⁻¹, such as from about 1×10⁻⁶ K⁻¹ to about 5×10⁻⁶ K⁻¹, such as from about 2×10⁻⁶ K⁻¹ to about 4×10⁻⁶ K⁻¹. In some embodiments, the filler can have a CTE value that is from about 0.1×10⁻⁶ K⁻¹ to about 5×10⁻⁶ K⁻¹, such as from about 0.1×10⁻⁶ K⁻¹ to about 2×10⁻⁶ K⁻¹, such as from about 0.2×10⁻⁶ K⁻¹ to about 1×10⁻⁶ K⁻¹. Other values are contemplated. An illustrative, but non-limiting, example of a low CTE filler is fused silica, such as Silbond FW (Quarzwerke).

Fillers can be of various particle diameters. In some embodiments, the filler can have a D50 particle diameter such as from about 1 μm to about 100 μm, such as about 35 μm or more, or from about 15 μm to about 30 μm, or from about 1 μm to about 4 μm. In at least one embodiment, the D50 particle diameter of the filler can be in a range from about 35 μm to 80 μm, such as from about 40 μm to about 70 μm, such as from about 45 μm to about 60 μm. Additionally, or alternatively, the D50 particle diameter of the filler can be in a range from about 15 μm to about 25 μm, such as from about 15 μm to about 20 μm or from about 20 μm to about 25 μm. Additionally, or alternatively, the D50 particle diameter of the filler can be in a range from about 1 μm to about 3 μm, such as from about 1 μm to about 2 μm or from about 2 μm to about 3 μm. Other D50 particle diameters are contemplated. The D50 particle diameter is a particle diameter (median diameter) at 50% of accumulation of particle size distribution on a mass basis, which means a particle diameter at the point where the cumulative value becomes 50% in the cumulative curve that the particle size distribution is obtained on a mass basis and the whole mass is set to 100%. Such a D50 particle diameter can be measured by laser diffraction. Laser diffraction can be accomplished by using a MASTERSIZER3000 instrument from Marvern Inc., based on ISO-13320 standard, with ethanol as a solvent. The incident laser is scattered by the particles dispersed in the solvent, and the intensity and the directional value of the scattered laser vary depending on the size of the particles, which are analyzed using the Mie theory. Through the above analysis, the particle diameter can be evaluated by obtaining the distribution through conversion to the diameter of a sphere having the same volume as that of the dispersed particle and obtaining the D50 value as the median value of the distribution through that.

The filler can have any suitable shape. The choice of the shape of the filler can be based on, for example, insulation, filling effect, dispersibility, viscosity of the epoxy resin composition, thixotropy of the epoxy resin composition, settling possibility in the epoxy resin composition, desired thermal resistance, desired thermal conductivity, combinations thereof, among other reasons. Shapes of the filler include spherical fillers, substantially spherical fillers, non-spherical fillers (for example, needle shape, plate shape, among others), or combinations thereof.

Combinations or blends, in any suitable proportions, of fillers can be utilized for epoxy resin compositions described herein. Such combinations can include more than one type of filler (for example, silica and epoxysilane pre-treated silica), more than one size of filler (for example, silicon carbide having a D50 particle diameter of about 1.5 μm to about 4 μm and a silicon carbide having a D50 particle diameter of about 20 μm to about 35 μm), more than one shape (for example, spherical and needle shape), or combinations thereof.

A total amount of filler(s) in epoxy resin compositions described herein can be from about 30 wt % to about 80 wt %, such as from about 30 wt % to about 70 wt %, such as from about 40 wt % to about 60 wt %, such as from about 45 wt % to about 55 wt % based on a total wt % of the epoxy resin composition. Other amounts are contemplated. In some embodiments, a total amount (wt %) of filler(s) in epoxy resin compositions described herein, based on the total wt % of the epoxy resin composition, can be 30, 35 40, 45, 50, 55, 60, 65, 70, 75, or 80, or ranges thereof. Each of the foregoing numbers can be preceded by the word “about,” “at least about,” “less than about,” or “more than about,” and any of the foregoing numbers can be used singly to describe an open-ended range or in combination to describe a close-ended range.

In some examples, a weight ratio of a total amount of epoxy resin to a total amount of filler in epoxy resin compositions described herein can be any suitable ratio or range. In some examples, a weight ratio of a total amount of epoxy resin to a total amount of filler in epoxy resin compositions described herein can be from about 1:10 to about 10:1, such as from about 1:8 to about 8:1, such as from about 1:5 to about 5:1, such as from about 1:3 to about 3:1, such as from about 1:2.5 to about 2.5:1, such as from about 1:2 to about 2:1, such as from about 1:1.5 to about 1.5:1. In at least one embodiment, a weight ratio of the total amount of epoxy resin to a total amount of filler in epoxy resin compositions described herein can be 1:10, 1:9.5, 1:9, 1:8.5, 1:8, 1:7.5, 1:7, 1:6.5, 1:6, 1:5.5, 1:5, 1:4.5, 1:4, 1:3.9, 1:3.8, 1:3.7, 1:3.6, 1:3.5, 1:3.4, 1:3.3, 1:3.2, 1:3.1, 1:3, 1:2.9, 1:2.8, 1:2.7, 1:2.6, 1:2.5, 1:2.4, 1:2.3, 1:2.2, 1:2.1, 1:2, 1:1.9, 1:1.8, 1:1.7, 1:1.6, 1:1.5, 1:1.4, 1:1.3, 1:1.2, 1:1.1, 1:1, 1.1:1, 1.2:1, 1.3:1, 1.4:1, 1.5:1, 1.6:1, 1.7:1, 1.8:1, 1.9:1, 2:1, 2.1:1, 2.2:1, 2.3:1, 2.4:1, 2.5:1, 2.6:1, 2.7:1, 2.8:1, 2.9:1, 3:1, 3.1:1, 3.2:1, 3.3:1, 3.4:1, 3.5:1, 3.6:1, 3.7:1, 3.8:1, 3.9:1, 4:1, 4.5:1, 5:1, 5.5:1, 6:1, 6.5:1, 7:1, 7.5:1, 8:1, 8.5:1, 9:1, 9.5:1, or 10:1, or ranges thereof, though other weight ratios are contemplated.

In general, epoxy resin compositions described herein can be made or formed by preparing the first component, the second component, and the optional third component. The preparation of the first component and the second component can be carried out in conventional mixing units, such as intimate mixers or extruders, generally at room temperature. The first and second components are stable to storage and can be used as required. The materials (the first component, the second component, and the optional third component, or combinations thereof) of the epoxy resin composition can be introduced to one another and mixed, stirred, or agitated.

For example, the first component, the second component, and optionally the third component can be charged to a vessel and stirred, mixed, or otherwise agitated under mixing conditions effective to form an epoxy resin composition. Mixing conditions can include using a mixing pressure of about 10 mbar (˜1,000 Pa) to about 1,000 mbar (100,000 Pa), such as from about 20 mbar (˜2,000 Pa) to about 500 mbar (˜50,000 Pa), such as from about 30 mbar (3,000 Pa) to about 150 mbar (˜15,000 Pa), such as from about 40 mbar (˜4,000 Pa) to about 70 mbar (˜7,000 Pa), such as about 50 mbar (˜5,000 Pa), though other pressures are contemplated. In some examples, mixing conditions can include a mixing pressure (in Pa) of about 1,000, 2,000, 3,000, 4,000, 5,000, 6,000, 7,000, 8,000, 9,000, or 10,000, or ranges thereof, though other pressures are contemplated. Each of the foregoing numbers can be preceded by the word “about,” “at least about,” “less than about,” or “more than about,” and any of the foregoing numbers can be used singly to describe an open-ended range or in combination to describe a close-ended range.

Mixing conditions can include elevated temperature if desired. However, if elevated temperatures are used during mixing of the materials, the mixing temperature should be below the temperature at which a curing agent becomes active. For example, the materials can be mixed at a temperature that is from about 15° C. to about 120° C., such as from about 20° C. to about 110° C., such as from about 25° C. to about 100° C., such as from about 40° C. to about 90° C., such as from about 50° C. to about 80° C., such as from about 60° C. to about 75° C., though other temperatures are contemplated.

Mixing conditions can include stirring, mixing, agitating, or combinations thereof by using suitable devices such as a mechanical stirrer. Such mixing conditions can include use of suitable devices such as a mechanical stirrer (for example, an overhead stirrer), magnetic stirrer (for example, placing a magnetic stir bar in the vessel above a magnetic stirrer), or other suitable devices. For example, a stirrer (having a blade or propeller) can be rotated by receiving rotational power from a stirring motor to stir the one or more materials at suitable rotation speeds. Mixing conditions can include utilizing a non-reactive gas, such as N₂, Ar, or combinations thereof. For example, a non-reactive gas can be introduced to the first component, the second component, and the optional third component to degas various components or otherwise remove unwanted gases (for example, oxygen) from the mixture.

Mixing conditions can include use of suitable devices such as a mechanical stirrer, a magnetic stirrer, or other suitable devices, as described above. For example, a stirrer (having a blade or propeller) can be rotated by receiving rotational power from a stirring motor to stir the one or more materials at suitable rotation speeds, such as from about 50 revolutions per minute (rpm) to about 1,500 rpm, such as from about 75 rpm to about 1,000 rpm, such as from about 100 rpm to about 900 rpm, such as from about 200 rpm to about 800 rpm, such as from about 300 rpm to about 700 rpm, such as from about 400 rpm to about 600 rpm, such as from about 450 rpm to about 550 rpm, such as about 500 rpm. Any of the foregoing numbers can be used singly to describe an open-ended range or in combination to describe a close-ended range. Other rotation speeds are contemplated and can be selected based on the ability to mix the components sufficiently. Mixing, stirring, or agitating can be performed for any suitable period, such as from about 1 min to about 48 h, such as from about 5 min to about 24 h, such as from about 30 min to about 10 h, such as from about 1 h to about 5 h, such as from about 2 h to about 3 h, though other periods are contemplated. Any of the foregoing numbers can be used singly to describe an open-ended range or in combination to describe a close-ended range.

At this stage, the composition (for example, the epoxy resin composition) is formed and can be stored for immediate use, later use, or combinations thereof. In addition, and at this stage, the composition can be a curable composition such that the composition can be cured by application of a stimulus (such as heat). The curable composition can be in the form of a liquid, paste, or gel. One or more of the materials of the curable composition can be dispersed or suspended, as particles.

Epoxy resin compositions described herein can be utilized, for example, to stabilize rotor core designs used for high reluctance torque electric motors (for example, synchronous reluctance motors and PMAR motors). Conventional compositions cannot withstand the high stresses caused by exposure to a wide range of temperatures (for example, from −40° C. to 180° C.), high centrifugal forces during operation of the motors, among other damaging and degrading stresses and forces present during operation of electric motors.

In contrast, epoxy resin compositions described herein can withstand various of the aforementioned stresses and forces. For example, epoxy resin compositions described herein can have a coefficient of thermal expansion (CTE) that better matches the CTE values of substrates present in electric motors. In some embodiments, epoxy resin compositions described herein can have a CTE value of about 10×10⁻⁶ K⁻¹ to about 25×10⁻⁶ K⁻¹, such as from about 10×10⁻⁶ K⁻¹ to about 20×10⁻⁶ K⁻¹, such as from about 10×10⁻⁶ K⁻¹ to about 15×10⁻⁶ K⁻¹, though other values are contemplated. CTE is determined by ASTM D696.

As a result of, for example, the better matching CTE values, the epoxy resin compositions show improved resistance to cracking under thermal stress, mechanical stress, among other damaging or degrading forces.

### Coated Substrates

Embodiments described herein also generally relate to articles, such as coated substrates, and to methods of making articles, such as methods of making coated substrates. Methods described herein can result in superior adhesion of epoxy resin compositions described herein to substrates over existing methods.

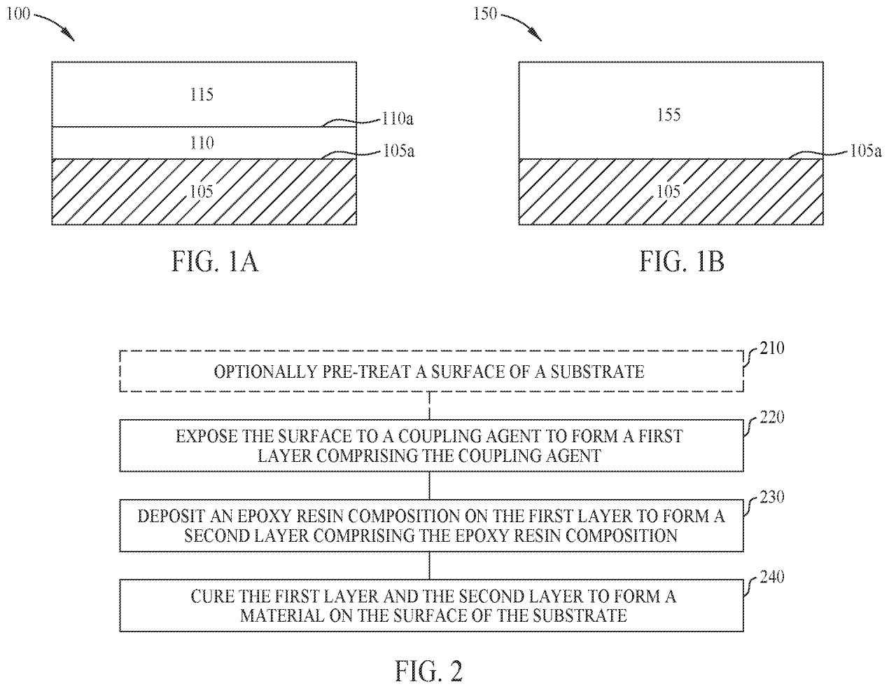

FIG. 1A is a side view of a coated substrate 100 according to at least one embodiment of the present disclosure. The coated substrate 100 includes a first layer 110 (or a film, a coating, or the like) comprising, consisting essentially of, or consisting of a coupling agent disposed on, over, or within, a surface 105a of a substrate 105. The coated substrate 100 further includes a second layer 115 (or a film, a coating, or the like) disposed on, over, or within, a surface 110a of the first layer 110. The second layer 115 can comprise, consist essentially of, or consist of an epoxy resin composition. The epoxy resin composition can be an adhesive composition, though the designation as an adhesive composition is non-limiting. Although the first layer 110 and the second layer 115 are shown in FIG. 1A as being disposed on one surface of the substrate 105, the first layer 110 and the second layer 115 may be disposed directly or indirectly on, over, or within one or more surfaces of the substrate 105.

The epoxy resin composition can be, or include, any epoxy resin composition described herein or other suitable epoxy resin composition. The substrate 105 can be any suitable substrate, and can include any suitable structure that benefits from the epoxy resin composition being disposed thereon. The substrate 105 can define one or more components (such as structural components or mechanical components) of an apparatus that are exposed to, for example, thermal stress, mechanical stress, centrifugal forces, among other damaging or degrading forces. Such apparatus can include, for example, land vehicles, aircraft, watercraft, spacecraft, equipment, and other apparatus that can be susceptible to stresses or other damaging or degrading forces. The substrate 105 can be a part of a larger structure such as a vehicle component. A vehicle component can be any suitable component of a vehicle.

The substrate 105 can be an electric motor, a synchronous reluctance motor, a PMAR motor, a component thereof, or combinations thereof, among other substrates. Components electric motors can include a rotor, a stator, a blade, an electric steel sheet, a grain-oriented sheet, a joint, a panel, one or more portions of an electric motor that carry a mechanical load, among other components. In some embodiments, the substrate 105 includes a cutting edge of a stator electric steel sheet.

In some embodiments, the substrate 105 can be a metal substrate. Metal substrates can be made from or include suitable materials such as aluminum, aluminum alloy, nickel, iron, iron alloy, steel, electrical steel, titanium, titanium alloy, copper, copper alloy, or combinations thereof, such as steel, electrical steel, or combinations thereof.

Additionally, or alternatively, the substrate can be a magnet such as a permanent magnet. Any suitable permanent magnet can be utilized. For example, a neodymium magnet (also referred to as neodymium iron boron (NdFeB) magnet) can be used such as that described in U.S. Pat. No. 9,960,646 entitled “Fixing Resin Composition for Use in Rotor” which is incorporated herein by reference in its entirety to the extent not inconsistent with the present disclosure. Additionally, or alternatively, non-limiting examples of permanent magnets can include samarium cobalt, Alnico magnet (comprising aluminum, nickel, and cobalt), among others. In some embodiments, the substrate comprises a magnet selected from the group consisting of neodymium magnet, samarium cobalt, Alnico magnet, and combinations thereof. Some electric motors, such as those used for e-mobility among other applications, rely upon a electromagnet, a permanent magnet, or combinations thereof.

The substrate 105 to be coated with the first layer 110 and the second layer 115 can be a bare substrate, for example, a substrate having no plating (unplated metal), conversion coating, or other coating. Additionally or alternatively, the substrate 105 to be coated can have plating, a conversion coating, or other coating. That is, the first layer 110 and the second layer 115 can be directly or indirectly disposed (for example, bonded or adhered) to the substrate 105.

The first layer 110 and the second layer 115 can be a material or a coating. Additionally, or alternatively, the first layer 110 and the second layer 115 can form a composite material upon, for example, curing. That is, the material or coating can be a curable material cured by application of a stimulus (such as heat), though curing can also be performed at room temperature (a temperature from about 15° C. to about 25° C.). The material can be a cured product of the coupling agent and the epoxy resin composition, and wherein the cured product comprises a composite material.

The material or coating, whether cured or not, can exist as a single layer or as multiple layers. Upon curing, a component in the first layer 110 (for example, a coupling agent) and a component in the second layer 115 can react to form a reaction product or a cured product. For example, a component of the second layer 115 (such as an epoxy resin, an alcohol, a curing agent, a polycaprolactone-polysiloxane block copolymer, one or more optional additives, or combinations thereof) can react with the coupling agent present in the first layer 110 to form a reaction product (or cured product). This reaction product (or cured product) may exist as a single layer or multiple layers disposed directly or indirectly on, over, or within one or more surfaces of substrate 105. That is, a coated substrate described herein can include a substrate and a composite material disposed on, over, or within one or more surfaces of the substrate. FIG. 1B shows a side view of a coated substrate 150 where the composite material is a single layer 120 disposed on the surface 105a of the substrate 105 according to at least one embodiment of the present disclosure.

In some embodiments, the curable material can be in the form of a liquid, paste, or gel. Additionally, or alternatively, the curable material can be in the form of one or more layers, films, or similar structures. One or more of the components of the curable material can be dispersed or suspended, as particles.

In some embodiments, a material is disposed on a substrate, the material comprising: a coupling agent and an epoxy resin composition. The coupling agent can be disposed on a surface of the substrate and the epoxy resin composition can be disposed on the substrate. The material can be a cured product of the coupling agent and the epoxy resin composition, and wherein the cured product comprises a composite material.

Materials, coatings, and composite materials described herein can include a coupling agent, an epoxy resin composition described, one or more optional components, a reaction product thereof, a cured product thereof, or combinations thereof.

Coupling agents can serve to help adhere epoxy resin compositions described herein to a substrate surface. As described above, the coupling agent can form a portion of a composite material and an epoxy resin composition described herein can form another portion of the composite material.

In some embodiments, the coupling agent comprises, consists essentially of, or consists of a compound or species having a functional group that is reactive towards an epoxide group. Such coupling agents can comprise, consist essentially of, or consist of a sulfur-containing species, a nitrogen-containing species, a silicon-containing species, or combinations thereof, among others. It should be noted that a coupling agent can include a sulfur atom, a nitrogen atom, a silicon atom, or combinations thereof. The coupling agent interacts chemically, physically, or both, with one or more functional groups present in an epoxy resin composition described herein. For example, when the coupling agent of the first layer 110 comprises one or more thiol groups (also known as mercaptan groups), the thiol group can interact with one or more epoxide groups of the epoxy resin composition of the second layer 115. In such a way, the thiol group (or other functional group of the coupling agent) present in the first layer 110 can promote adherence of the epoxy resin composition of the second layer 115 to the substrate 105.

Various sulfur-containing species can be utilized. The term “sulfur-containing species” can be interchangeably referred to as a “sulfur-containing compound”, such that reference to one includes reference to the other.

In some embodiments, a non-limiting example of a sulfur-containing species can be represented by formula (IV):

R⁷—SH (IV).

The sulfur-containing species represented by formula (IV) is a thiol (also known as a mercaptan). R⁷ of formula (IV) can be an unsubstituted hydrocarbyl or a substituted hydrocarbyl. R⁷ of formula (IV) may be linear or branched, saturated or unsaturated, cyclic or acyclic, aromatic or not aromatic. Regarding saturation, R⁷ of formula (IV) can be fully saturated, partially unsaturated, or fully unsaturated. In some embodiments, R⁷ of formula (IV) can have any suitable number of carbon atoms, such as from 1 to 400 carbon atoms, such as from 1 to 300 carbon atoms, such as from 1 to 200 carbon atoms, such as from 1 to 100 carbon atoms, such as from 1 to 40 carbon atoms, such as from 1 to 20 carbon atoms, such as from 1 to 10 carbon atoms, such as from 1 to 5 carbon atoms, such as from 1 to 4 carbon atoms, though other values are contemplated. Any of the foregoing numbers can be used singly to describe an open-ended range or in combination to describe a close-ended range. In some embodiments, R⁷ of formula (IV) can be linear or branched alkyl, linear or branched alkenyl, or aryl.

Non-limiting examples of unsubstituted hydrocarbyls for R⁷ of formula (IV) can include an alkyl group having, for example, from 1 to 400 carbon atoms (such as 1 to 20 carbon atoms) such as methyl, ethyl, n-propyl, isopropyl, n-butyl, iso-butyl, sec-butyl, and tert-butyl, pentyl, hexyl, heptyl, octyl, ethyl-2-hexyl, isooctyl, nonyl, n-decyl, isodecyl, or isomers thereof; a cycloaliphatic group having from 3 to 20 carbon atoms such as, for example, cyclopentyl or cyclohexyl; an aromatic group having from 6 to 20 carbon atoms such as, for example, phenyl or naphthyl; or any combination thereof.

In some embodiments, R⁷ of formula (IV) can be a substituted hydrocarbyl in which at least one hydrogen of an unsubstituted hydrocarbyl has been substituted with at least one heteroatom or heteroatom-containing group, such as one or more elements from Group 13-17 of the periodic table of the elements, such as halogen (F, Cl, Br, or I), O, N, Se, Te, P, As, Sb, S, B, Si, Ge, Sn, Pb, and the like, such as C(O)R*, C(C)NR*₂, C(O)OR*, NR*₂, OR*, SeR*, TeR*, PR*₂, AsR*₂, SbR*₂, SR*, SOₓ (where x=2 or 3), BR*₂, SiR*₃, GeR*₃, SnR*₃, PbR*₃, and the like, where R* is, independently, hydrogen or unsubstituted hydrocarbyl, or where at least one heteroatom has been inserted within the unsubstituted hydrocarbyl.

In some examples, R⁷ of formula (IV) includes a functional group such as an amine (NR*₂), a carboxylic acid (—COOH), an ester (C(O)R*), or combinations thereof, where R* is, independently, hydrogen or unsubstituted hydrocarbyl, or where at least one heteroatom has been inserted within the unsubstituted hydrocarbyl.

Illustrative, but non-limiting, examples of sulfur-containing species that can be used as a coupling agent include:
(a) Mercaptan-terminated polysulfide polymers, known by the Thiokol trade name (from Morton Thiokol; available, for example, from SPI Supplies, or from Toray Fine Chemicals), such as the LP-3, LP-33, LP-980, LP-23, LP-55, LP-56, LP-12, LP-31, LP-32 or LP-2 products; and also known by the Thioplast brand name (from Akzo Nobel), such as the G10, G112, G131, G1, G12, G21, G22, G44, and G4 products;
(b) Mercaptan-terminated polyoxyalkylene derivatives, obtainable, for example, by reaction of polyoxyalkylenediols or polyoxyalkylenetriols either with epichlorohydrin or with an alkylene oxide, followed by sodium hydrogensulfide, commercially available, for example, as Gabepro GPM-800 (from Gabriel Performance Products) or under the Capcure brand name (from Cognis), such as the WR-8, LOF, and 3-800 products;
(c) Polyesters of thiocarboxylic acids, for example pentaerythritol tetramercaptoacetate, trimethylolpropane trimercaptoacetate, glycol dimercaptoacetate, pentaerythritol tetra(3-mercaptopropionate), trimethylolpropane tri(3-mercaptopropionate) or glycol di(3-mercaptopropionate), or esterification products of polyoxyalkylenediols or -triols, ethoxylated trimethylolpropane or polyester diols with thiocarboxylic acids such as thioglycolic acid, 2-mercaptopropionic acid, or 3-mercaptopropionic acid;
(d) Other compounds having mercapto groups, such as 2,4,6-trimercapto-1,3,5-triazine, 2,2′-(ethylenedioxy)diethanethiol (triethylene glycol dimercaptan), or ethanedithiol;
(e) Primary thiols, secondary thiols, or tertiary thiols having from 1 to 20 carbon atoms, such as L-cysteine (CAS No. 52-90-4) or 2-ethylhexyl thioglycolate (2EHTG; CAS No. 7659-86-1); and
(f) Primary polythiols, secondary polythiols, and tertiary polythiols having from 1 to 20 carbon atoms, such as 1,2,6-hexanetriyl tris(mercaptoacetate) (HTM; CAS No. 19759-80-9). Polythiols are sulfur-containing species having more than one thiol group.

One or more sulfur-containing species can be utilized together, if desired.

Coupling agents that can be used also include a nitrogen-containing species (interchangeably referred to as a nitrogen-containing compound), such as:
(a) Primary monoamines such as hexylamine, benzylamine, furfurylamine, or combinations thereof, among others;
(b) Aromatic polyamines such as m-phenylenediamine, p-phenylenediamine, 4,4′-diaminodiphenylmethane, 2,4′-diaminodiphenylmethane, 2,2′-diaminodiphenylmethane, 3,3′-dichloro-4,4′-diaminodiphenylmethane (MOCA), tolylene-2,4-diamine, tolylene-2,6-diamine, mixtures of 3,5-dimethylthiotolylene-2,4-diamine and 3,5-dimethylthiotolylene-2,6-diamine (available as Ethacure 300 from Albemarle), mixtures of 3,5-diethyltolylene-2,4-diamine and 3,5-diethyltolylene-2,6-diamine (DETDA), 3,3′,5,5′-tetraethyl-4,4′-diaminodiphenylmethane (M-DEA), 3,3′,5,5′-tetraethyl-2,2′-dichloro-4,4′-diaminodiphenylmethane (M-CDEA), 3,3′-diisopropyl-5,5′-dimethyl-4,4′-diaminodiphenylmethane (M-MIPA), 3,3′,5,5′-tetraisopropyl-4,4′-diaminodiphenylmethane (M-DIPA), 4,4′-diaminodiphenylsulfone (DDS), 4-amino-N-(4-aminophenyl)benzenesulfonamide, 5,5′-methylenedianthranilic acid, dimethyl 5,5′-methylenedianthranilate, propylene 1,3-bis(4-aminobenzoate), butylene 1,4-bis(4-aminobenzoate), polytetramethylene oxide bis(4-aminobenzoate) (available as Versalink from Air Products), 1,2-bis(2-aminophenylthio)ethane, 2-methylpropyl 4-chloro-3,5-diaminobenzoate, tert-butyl (4-chloro-3,5-diaminobenzoate), or combinations thereof, among others;
(c) Polyamidoamines, such as reaction products of a monobasic or polybasic carboxylic acid, or the esters or anhydrides thereof, such as a dimer fatty acid, with an aliphatic, cycloaliphatic or aromatic polyamine used in a stoichiometric excess, such as a polyalkyleneamine, for example diethylenetriamine (DETA) or triethylenetetramine (TETA), such as the commercially available polyamidoamines Versamid 100, 125, 140, or 150 (from Cognis), Aradur 223, 250, or 848 (from Huntsman), Euretek 3607 or 530 (from Huntsman) or Beckopox EH 651, EH 654, EH 655, EH 661, or EH 663 (from Cytec), or combinations thereof, among others; and
(d) Mannich bases obtained from the reaction of phenols with aldehydes, especially formaldehyde, and aliphatic or cycloaliphatic amines, especially phenalkamines, i.e., Mannich bases of cardanol (long-chain alkylphenols, alkenylphenols, alkylresorcinols, or alkenylresorcinols obtained by thermal treatment of cashewnutshell oil extracts, containing as main component 3-(pentadeca-8,11,14-trienyl)phenol, such as the commercial products Cardolite NX-5607 or NX-5608 (from Cardolite), or Aradur 3440, 3441, 3442 or 3460 (from Huntsman), or Beckopox EH 614, EH 621, EH 624, EH 628 or EH 629 (from Cytec), or combinations thereof, among others.

One or more nitrogen-containing species can be utilized together, if desired.

Coupling agents that can be used also include a silicon-containing species (interchangeably referred to as a silicon-containing compound), such as:

Other coupling agents that can be used as at least a portion of first layer 110 include epoxy silane coupling agents, cationic silane coupling agent, aminosilane coupling agent, titanate coupling agent, and silicone oil coupling agent, be used. Examples thereof include amino silane compounds such as N-phenyl-3-aminopropyltrimethoxysilane, 3-aminopropyltrimethoxysilane, 3-aminopropyltriethoxysilane, 3-(2-aminoethyl)aminopropyltrimethoxysilane, 3-(2-aminoethyl)aminopropyltriethoxysilane, 3-anilinopropyltrimethoxysilane, 3-anilinopropyltriethoxysilane, N-β-(N-vinylbenzylaminoethyl)-3-aminopropyltrimethoxysilane, and N-β-(N-vinylbenzylaminoethyl)-3-aminopropyltriethoxysilane; epoxy silane compounds such as 3-glycidoxypropyltrimethoxysilane, 3-glycidoxypropyltriethoxysilane, and 2-(3,4-epoxycyclohexyl)ethyltrimethoxysilane; and other coupling agents such as 3-mercaptopropyltrimethoxysilane, 3-mercaptopropyltriethoxysilane, 3-ureidopropyltrimethoxysilane, 3-ureidopropyltriethoxysilane, and 3-methacryloxypropyltrimethoxysilane. An example of a commercially available epoxy silane coupling agent is Silquest A-187 (Momentive Performance Materials).

One or more silicon-containing species can be utilized together, if desired.

In some embodiments, one or more coupling agents are utilized, such as one or more sulfur-containing species, one or more nitrogen-containing species, one or more silicon-containing species, combinations thereof, in any suitable proportions. For example, a mixture of L-cysteine and 2-ethylhexyl thioglycolate can be used. As another example, a mixture of Silquest A-187 (epoxy silane coupling agent) and L-cysteine can be used. Other mixtures of coupling agents are contemplated.

As described below, embodiments of methods for coating a substrate include treatment of the substrate 105. The treatment can enable improved adhesion of the epoxy resin composition to the substrate surface. In electric motor applications, the improved adhesion of the epoxy resin composition to the steel surface can support the high-speed operation of electric motors. Further, epoxy resin compositions described herein can withstand high thermal stresses and high centrifugal forces caused by the high rotational speeds observed during operation of electric motors.

### Methods of Coating Substrates

Embodiments of the present disclosure also relate to methods of coating substrates. Such methods can be used to form coated substrates (for example, coated substrate 100 and coated substrate 150). As described above, the inventor found that depositing a coupling agent on a substrate surface prior to depositing an epoxy resin composition can promote adhesion between the substrate and the epoxy resin composition.

FIG. 2 shows selected operations of a method 200 of coating a substrate according to at least one embodiment of the present disclosure. During method 200, suitable solvents can be used during various operations. Suitable solvents used during one or more operations of method 200 include, but are not limited to, aqueous solvents (for example, water, distilled water, deionized water, and ultra pure water), organic solvents, or combinations thereof. Organic solvents can include halogenated solvents, such as chlorocarbon solvents such as dichloromethane and chloroform; alcohol solvents such as ethanol (EtOH), methanol, isopropanol, n-propanol, n-butanol, isobutanol, sec-butanol, an amyl alcohol (such as n-pentanol, isopentanol, and sec-pentanol); alkylcarbonate solvents such as dimethyl carbonate, diethyl carbonate, and dipropyl carbonate; ketone solvents such as acetone, hydrocarbon solvents such as hexane, pentane, benzene, and toluene; ether solvents such as dimethyl ether, diethyl ether, tetrahydrofuran, dipropylene glycol dimethyl ether, and glycol ether; among other solvents such as ethyl acetate, dimethylformamide, acetonitrile, N-methyl-2-pyrrolidone, dimethyl sulfoxide, or a combination thereof. Mixtures of two or more of these solvents, in suitable proportions, can be utilized.

Referring to FIG. 2, the method 200 begins with optionally pre-treating a surface (for example, surface 105a) of the substrate 105 at optional operation 210. Pre-treating can include cleaning the surface 105a, degreasing the surface 105a, alkaline washing of the surface 105a, chemical etching of the surface 105a, mechanically deoxidizing the surface 105a (such as by polishing, sanding, abrading, or combinations thereof), chemically deoxidizing the surface 105a, or combinations thereof, among other suitable approaches for making a surface 105a compatible for later operations of the method 200 (for example, operation 220).

In some embodiments, degreasing of the surface 105a of the substrate 105 during optional operation 210 can be performed by washing the surface 105a with any suitable solvent. Suitable solvents for degreasing include one or more of those described above, such as a chlorocarbon solvent (for example, dichloromethane or chloroform). Degreasing can be performed for any suitable period such as from about 1 minute to about 30 minutes, such as from about 5 minutes to about 20 minutes, such as about 5 minutes to about 10 minutes, such as from about 10 minutes to about 15 minutes. Any of the foregoing numbers can be used singly to describe an open-ended range or in combination to describe a close-ended range. Other periods are contemplated.

In some examples, mechanically deoxidizing the surface 105a of the substrate 105 during optional operation 210 can be performed by, for example, utilizing sandpaper or an abrasion agent using any suitable apparatus. For example, sandpaper with a suitable grit (for example, 120 grit) can be utilized.

When chemical deoxidizing the surface 105a of the substrate 105 is performed during optional operation 210, the chemical deoxidizing can include use of any suitable chemical deoxidizing agent. Various chemical deoxidizing agents can be used including citric acid triammonium salt (CAS No. 3458-72-8), phosphoric acid (CAS No 7664-38-2), hydrochloric acid (CAS No. 4647-01-0), an ion thereof, combinations thereof, among others. The chemical deoxidizing agent can be in the form of a mixture (for example, a solution or suspension) comprising a chemical deoxidizing agent and a solvent. Suitable solvents can include an aqueous solvent, an organic solvent, or both, such as those solvents described above. In some examples, the solvent is water. A concentration of the chemical deoxidizing agent in the mixture can be any suitable concentration such as from about 1 wt % to about 10 wt %, such as from about 2 wt % to about 8 wt %, such as from about 3 wt % to about 5 wt %, such as 1, 2, 3, 4, 5, 6, 7, 8, 9, or 10 wt %. Each of the foregoing numbers can be preceded by the word “about,” “at least about,” “less than about,” or “more than about,” and any of the foregoing numbers can be used singly to describe an open-ended range or in combination to describe a close-ended range. Other concentrations are contemplated.

Chemical deoxidizing during the optional operation 210 include exposing the surface 105a of the substrate 105 to a chemical deoxidizing agent (or mixture comprising a chemical deoxidizing agent). As used in the context of method 200, the term “exposing” can include contacting or introducing two or more elements by any suitable means unless the context indicates otherwise. For example exposing the surface 105a of the substrate 105 to a chemical deoxidizing agent includes introducing the surface 105a with a chemical deoxidizing agent as well as contacting the surface 105a with a chemical deoxidizing agent.

Chemical deoxidizing during the optional operation 210 can include dipping or immersing the surface 105a of the substrate 105 in the chemical deoxidizing agent (or the mixture comprising the chemical deoxidizing agent). Additionally, or alternatively, the surface 105a of the substrate 105 can be sprayed with the chemical deoxidizing agent (or the mixture comprising the chemical deoxidizing agent). The chemical deoxidizing agent (or the mixture comprising the chemical deoxidizing agent) can be set to a selected temperature, such as from about 15° C. to about 90° C., such as from about 20° C. to about 80° C., such as from about 25° C. to about 75° C., such as from about 30° C. to about 60° C., such as from about 40° C. to about 50° C., or from about 50° C. to about 60° C., or from about 40° C. to about 90° C., or from about 50° C. to about 90° C., or about 25, 30, 35, 40, 45, 50, 55, 60, 65, 70, 75, 80, 85, or 90° C., or ranges thereof, such as about 60° C. or about 80° C. Any of the foregoing numbers can be used singly to describe an open-ended range or in combination to describe a close-ended range. Other temperatures are contemplated. The temperature of the chemical deoxidizing agent (or the mixture comprising the chemical deoxidizing agent) can be monitored by a thermocouple.

Chemical deoxidizing during the optional operation 210 can be performed for any suitable period, such as from about 1 minute to about 1 hour, such as from about 5 minutes to about 45 minutes, such as from about 10 minutes to about 30 minutes, such as from about 15 minutes to about 25 minutes, or about 10 minutes, though other periods are contemplated. Any of the foregoing numbers can be used singly to describe an open-ended range or in combination to describe a close-ended range.

In some embodiments, the chemical deoxidizing agent (or the mixture comprising the chemical deoxidizing agent) can be stirred while exposing the substrate to the chemical deoxidizing agent (or the mixture comprising the chemical deoxidizing agent) during optional operation 210.

In some embodiments, and after the optional pre-treatment of optional operation 210, the surface 105a of the substrate 105 can be rinsed with, washed with, sprayed with, introduced with, dipped in, immersed in, exposed to, or otherwise contacted with, one or more of the solvents described above. For example, the surface 105a of the substrate 105 can be rinsed or washed with water and then with ethanol. Rinsing, washing, dipping, spraying, introducing, immersing, exposing or otherwise contacting with a solvent can be repeated one or more times. If desired, exposing the surface 105a of the substrate 105 to the chemical deoxidizing agent (or mixture comprising the chemical deoxidizing agent) can be repeated one or more times.

As described above, pre-treatment is optional such that method 200 can be free of a pre-treatment.

Method 200 further includes exposing a surface (for example, surface 105a) of the substrate 105 to a coupling agent at operation 220. Non-limiting examples of coupling agents are described above. In some examples, the coupling agent can be in the form of a mixture (for example, a solution or suspension) comprising the coupling agent and a solvent. The coupling agent can be in the form of an ion(s) when in a mixture. Suitable solvents can include an aqueous solvent, an organic solvent, or both, such as those solvents described above. In some examples, the solvent comprises ethanol, methanol, water, or combinations thereof Δ concentration of the coupling agent in the mixture comprising the coupling agent can be any suitable concentration such as from about 1 wt % to about 20 wt %, such as from about 3 wt % to about 15 wt %, such as from about 5 wt % to about 13 wt %, such as from about 6 wt % to about 10 wt %. In at least one embodiment, a concentration (wt %) of the coupling agent in the mixture comprising the coupling agent can be 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or 20, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other concentrations are contemplated.

In some embodiments, the mixture comprising the coupling agent and solvent can optionally include one or more additional components, such as an acid. The acid can be utilized to help dissolution of the coupling agent in the mixture comprising the coupling agent.

The acid can be any suitable acid such as an inorganic acid, an organic acid, an ion thereof, or a combination thereof. Illustrative, but non-limiting, examples of inorganic acids include HCl, H₂SO₄, HNO₃, HBr, HI, H₃PO₄, Lewis acids (for example, FeCl₃), an ion thereof, or combinations thereof. Illustrative, but non-limiting, examples of organic acids include C₁-C₂₅ carboxylic acid, such as a C₃-C₁₀ carboxylic acid, such as a C₃-C₇ carboxylic acid, such as acetic acid, oxalic acid, citric acid, formic acid, lactic acid, uric acid, malic acid, tartaric acid, trifluoroacetic acid, an ion thereof, or combinations thereof, such as acetic acid, HCl, an ion thereof, or combinations thereof. Additionally, or alternatively, sulfonic acids such as a C₁-C₂₅ sulfonic acid, such as a C₃-C₁₀ sulfonic acid, such as a C₃-C₇ sulfonic acid, such as trifluorosulfonic acid, or combinations thereof can be utilized.

A concentration of acid in the mixture comprising the coupling agent can be from about 0.05 wt % or more, 20 wt % or less, or combinations thereof, such as from about 0.1 wt % to about 15 wt %, such as from about 0.2 wt % to about 10 wt %, such as from about 0.3 wt % to about 5 wt %. In some embodiments, a concentration of acid in the mixture comprising the coupling agent can be from about 0.05 wt % to about 2 wt %, such as from about 0.1 wt % to about 1 wt %, such as from about 0.2 wt % to about 0.8 wt %, such as from about 0.4 wt % to about 0.6 wt %. In at least one embodiment, concentration of acid in the mixture comprising the coupling agent can be 0.05, 0.1, 0.15, 0.2, 0.25, 0.3, 0.35, 0.4, 0.45, 0.5, 0.6, 0.65, 0.7, 0.75, 0.8, 0.85, 0.9, 0.95, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or 20, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other concentrations are contemplated.

The mixture comprising the coupling agent can have a pH value that is about 1 or more, about 7.5, or less, or combinations thereof, such as from about 1 to about 7, such as from about 1 to about 6.5, such as from about 1 to about 5, about 2 to about 4, about 1 to about 3, or from about 2 to about 3. In at least one embodiment, the mixture comprising the coupling agent can have a pH value of 1, 1.5, 2, 2.5, 3, 3.5, 4, 4.5, 5, 5.5, 6, 6.5, 7, or 7.5, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other pH values or ranges are contemplated.

The exposing process of operation 220 can include dipping or immersing the surface 105a of the substrate 105 in the coupling agent (or the mixture comprising the coupling agent). Additionally, or alternatively, the surface 105a of the substrate 105 can be sprayed with the coupling agent (or the mixture comprising the coupling agent). Additionally, or alternatively, the coupling agent (or the mixture comprising the coupling agent) can be deposited on the surface 105a of the substrate 105. Additionally or alternatively, the coupling agent (or the mixture comprising the coupling agent) can be introduced with the surface 105a of the substrate 105.

During the exposing process of operation 220, the coupling agent (or the mixture comprising the coupling agent) can be set to a selected temperature, such as from about 15° C. to about 90° C., such as from about 20° C. to about 80° C., such as from about 25° C. to about 75° C., such as from about 30° C. to about 60° C., such as from about 40° C. to about 50° C., or from about 50° C. to about 60° C., or from about 40° C. to about 90° C., or from about 50° C. to about 90° C., or about 25, 30, 35, 40, 45, 50, 55, 60, 65, 70, 75, 80, 85, or 90° C., or ranges thereof, such as about 60° C. or about 80° C. Each of the foregoing numbers can be preceded by the word “about,” “at least about,” “less than about,” or “more than about,” and any of the foregoing numbers can be used singly to describe an open-ended range or in combination to describe a close-ended range. Other temperatures are contemplated. The temperature of the coupling agent (or the mixture comprising the coupling agent) can be monitored by a thermocouple.

In some embodiments, the coupling agent (or the mixture comprising the coupling agent) can be stirred while exposing the substrate to the coupling agent (or the mixture comprising the coupling agent) during operation 220.

Exposing the surface 105a of the substrate 105 to the coupling agent (or the mixture comprising the coupling agent) during operation 220 can be performed for any suitable period, such as from about 1 minute to about 1 hour, such as from about 5 minutes to about 45 minutes, such as from about 10 minutes to about 30 minutes, such as from about 15 minutes to about 25 minutes, such as about 15 minutes, though other periods are contemplated. Any of the foregoing numbers can be used singly to describe an open-ended range or in combination to describe a close-ended range.

After exposing the surface 105a of the substrate 105 to the coupling agent (or the mixture comprising the coupling agent), a layer or film comprising the coupling agent (for example, the first layer 110 comprising the coupling agent) can be formed on the surface 105a of the substrate 105. Although the coupling agent is described as forming a layer 110 (or film), it is not so limited. For example, the coupling agent can react with materials of the substrate such that a reaction product of the coupling agent with one or more elements/materials of the substrate is formed. In some embodiments, the first layer 110 can include a coupling agent, a reaction product of a coupling agent and one or more elements/materials of the substrate, or combinations thereof.

In some embodiments, and after exposing the surface 105a of the substrate 105 to the coupling agent (or the mixture comprising the coupling agent), the surface 110a of first layer 110 comprising the coupling agent, can be rinsed with, washed with, sprayed with, introduced with, dipped in, immersed in, exposed to, or otherwise contacted with, one or more of the solvents described above. For example, surface 110a of the first layer 110 can be rinsed with ethanol, water, or combinations thereof. Rinsing, washing, dipping, spraying, introducing, immersing, or otherwise contacting with can be repeated one or more times. If desired, exposing the surface 110a of the substrate 105 to the coupling agent (or mixture comprising the coupling agent) can be repeated one or more times.

Method 200 further includes depositing or otherwise introducing an epoxy resin composition described herein to a surface (for example, surface 110a) of the first layer 110 at operation 230. The epoxy resin composition can form a second layer 115 (or film) on the surface 110a of the first layer. Here, for example, an epoxy resin composition described herein can be deposited on or coated on the surface 110a of first layer 110 by using any suitable technique, such as by dipping, spraying, immersing. Additionally, or alternatively, the substrate-coupling agent (formed in operation 220) can be placed into a mold and encapsulated with an epoxy resin composition described herein. The epoxy resin composition can be made according to any suitable methods such as those described above.

Although the epoxy resin composition is described as being deposited on the surface of 110a and forming a second layer 115 (or film) on the first layer 110, the method is not so limited. For example, the epoxy resin composition can be deposited on (a) the coupling agent, (b) a reaction product of the coupling agent and one or more elements/materials of the substrate, (c) or both.

The epoxy resin composition can be deposited on the surface 110a of the first layer 110 within a selected amount of time after forming the first layer 110. In some embodiments, such a period can be about 1 minute to about 1 hour, such as from about 5 minutes to about 45 minutes, such as from about 10 minutes to about 30 minutes, such as from about 15 minutes to about 25 minutes. Any of the foregoing numbers can be used singly to describe an open-ended range or in combination to describe a close-ended range. In at least one embodiment, the amount of time between forming the first layer 110 and depositing the epoxy resin composition on the first layer 110 is about 30 minutes or less.

Once the epoxy resin composition is deposited on the surface 110a of first layer 110, a layer (for example, second layer 115) is formed on the first layer 110. As described above, the second layer 115 can comprise, consist essentially of, or consist of an epoxy resin composition described herein.

The coated substrate comprising the substrate 105, the first layer 110, the second layer 115, components thereof, or combinations thereof, can then be cured at operation 240. Curing of the first layer 110, the second layer 115, components thereof, or combinations thereof, forms a material comprising a composite material, the composite material comprising, consisting essentially of, or consisting of the coupling agent, the epoxy resin composition, components thereof, a reaction product thereof, or combinations thereof. The composite material formed during operation 240 can be in the form of a single layer or multiple layers.

The selected curing conditions of operation 240 can depend on, for example, the temperature at which the curing agent causes reactions to occur that resulting in coupling, cross-linking, or both, of the epoxy resin among other materials. For example, curing can take place between about room temperature (for example, when amine curing agents are used) and about 90° C. to about 180° C. (for example, when amine curing agents are used), though higher temperatures are contemplated. The selected curing conditions of operation 240 can additionally or alternatively depend on, for example, the temperature at which the coupling agent can react with materials present in the epoxy resin composition.

The curing temperature can be from about 15° C. to about 320° C., such as from about 30° C. to about 300° C., such as from about 40° C. to about 285° C., such as from about 50° C. to about 275° C., such as from about 75° C. to about 250° C., such as from about 100° C. to about 225° C., such as from about 125° C. to about 200° C., such as from about 150° C. to about 175° C., though other temperatures are contemplated. Any of the foregoing numbers can be used singly to describe an open-ended range or in combination to describe a close-ended range. Curing can be performed for any suitable amount of time, such as from about 1 min to about 48 h, such as from about 5 minutes (min) to about 24 hours (h), such as from about 30 min to about 10 h, such as from about 1 h to about 5 h, such as from about 2 h to about 3 h, though other periods are contemplated. Any of the foregoing numbers can be used singly to describe an open-ended range or in combination to describe a close-ended range.

The curing of operation 240 can be performed in stages, such as cure cycles. For example, a cure cycle can include curing at a first temperature at a first time; raising the temperature at a selected heating rate to a second temperature; and curing at a second temperature for a second time. As a non-limiting example, the cure cycle can have the following profile: curing at a temperature of about 100° C. to about 150° C. (such as about 120° C.) for a period of about 1 hour to about 3 hours (such as about 2 hours); raising the temperature to about 180° C. to about 200° C. (such as about 190° C.), at a rate of about 1° C./minute to about 10° C./minute (such as about 5° C./minute); and then curing at about 180° C. to about 200° C. (such as about 190° C.) for a period of about 2 hours to about 5 hours (such as about 2.5 hours, about 2.7 hours, or about 3 hours). Other cures or cure cycles are contemplated.

If desired, the substrate 105, the first layer 110, and second layer 115 can be introduced to a mold prior to curing. By use of a mold, the first layer 110, the second layer 115, or both can be shaped into any suitable shape. Depending on the application for which the coated substrate is to be used, corresponding shaping can be carried out. Depending on the material of the substrate 105, the substrate may also be molded into any suitable shape. Curing can then take place at a selected temperature or temperature range as described above.

Once the second layer 115 is deposited on the first layer 110, the layers are cured to provide a composite material comprising the second layer 115 (comprising an epoxy resin composition described herein) and the first layer 110 (comprising the coupling agent). As described above, the composite material may exist as a single layer comprising, consisting essentially of, or consisting of a coupling agent, an epoxy resin composition described herein, one or more additional components, or combinations thereof.

In some embodiments, the coated substrate can comprise, consist of, or consist essentially of: a substrate; and a composite material. The composite material can comprise, consist of, or consist essentially of: an epoxy resin composition and a coupling agent. Additionally, or alternatively, the composite material can comprise, consist of, or consist essentially of a reaction product of a coupling agent and a material present in the epoxy resin composition (such as one or more of the epoxy resin, alcohol, curing agent, polycaprolactone-polysiloxane block copolymer, optional additive, optional accelerant).

After depositing (for example, operation 230), curing (for example, operation 240), or combinations thereof, the substrate 105 having the composite material disposed thereon is suitable for exposure to an external environment, such as exposure to, for example, thermal stress, mechanical stress, centrifugal force, among other damaging stresses and forces and other degrading stresses and forces. Such stresses and forces are present in many environments, such as for example, electric motors, such as synchronous reluctance motors and PMAR motors, among other environments.

Composite materials described herein can have improved properties relative to conventional technologies. For example, a composite material can have improved flexural strength relative to conventional technologies.

When disposed on a substrate, and in some embodiments, a flexural strength of combined composite material described herein and the substrate can have a flexural strength that is greater than about 15 megapascals (MPa), about 150 MPa or less, or combinations thereof, such as from about 16 MPa to about from about 150 MPa, such as from about 25 MPa to about 140 MPa, such as from about 40 MPa to about 120 MPa, such as from about 50 MPa to about 100 MPa, such as from about 60 MPa to about 90 MPa, such as from about 70 MPa to about 80 MPa, foregoing numbers can be used singly to describe an open-ended range or in combination to describe a close-ended range. In at least one embodiment, the combined composite material and substrate can have a flexural strength of about 50 MPa or more, about 150 MPa or less, or combinations thereof, such as from about 50 MPa to about 100 MPa, such as about 55, 60, 65, 70, 75, 80, 85, 90, 95, 100, 105, 110, 115, 120, 125, 130, 135, 140, 145, or 150 MPa, or ranges thereof. Each of the foregoing numbers can be preceded by the word “about,” “at least about,” “less than about,” or “more than about,” and any of the foregoing numbers can be used singly to describe an open-ended range or in combination to describe a close-ended range. Other flexural strength values are contemplated. Flexural strength of the combined composite material and substrate is determined by the 4-point bending test as described in the Examples.

As described above, the epoxy resin composition (and the composite material thereof) can have a CTE value that better matches a CTE value of a component (for example, substrate 105) utilized in electric motors. As a result of, for example, the better matching CTE values, the composite materials show improved resistance to cracking under thermal stress, mechanical stress, centrifugal force, among other damaging or degrading stresses/forces during operation of electric motors.

The following examples are put forth so as to provide those of ordinary skill in the art with a complete disclosure and description of how to make and use embodiments of the present disclosure, and are not intended to limit the scope of embodiments of the present disclosure. Efforts have been made to ensure accuracy with respect to numbers used but some experimental errors and deviations should be accounted for.

### Examples

### Test Methods

Adhesion of the composite material to a steel bar (substrate) was determined by a 4-point bending test. The 4-point bending test is a measure of flexural strength (in Megapascals, MPa), and was determined according to ISO 178.

Adhesion of the composite material to a permanent magnet (substrate) was determined by measuring tensile strength (in units of MPa) according to ISO 527 standard.

### Materials

Steel bars were used as substrates for Examples 1-13. Neodymium iron boron (NdFeB) permanent magnets were utilized for Examples 14 and 15.

Different epoxy resin compositions were tested. Epoxy Resin Composition A (“Composition A”) is a cured composition of Epikote Resin 858 (an epoxy resin based on bisphenol A and mineral fillers), and Epikure 859/1 (a modified acid anhydride containing mineral filler-type curing agent). Epoxy Resin Composition B (“Composition B”) is a cured composition of Epikote Resin 05570 (epoxy resin based on bisphenol A and mineral fillers), Epikure 05556 (a modified acid anhydride containing mineral filler-type curing agent), and fused silica.

Example 12 was made with Composition B. All other examples and the comparative example were made with Composition A.

Different coupling agents were tested. These coupling agents included: 2-ethylhexyl thioglycolate (2EHTG, a sulfur-containing coupling agent); 1,2,6-hexanetriyl tris(mercaptoacetate) (HTM, a sulfur-containing coupling agent); L-cysteine (a sulfur-containing coupling agent); Silquest A-187 (an epoxy silane coupling agent); and Gabepro GPM 800 (a mercaptan-terminated polymer coupling agent).

Various non-limiting solvents (such as methanol, ethanol, and deionized water) utilized for the coupling agent mixtures were also tested. Some coupling agent mixtures also included a non-limiting acid such as acetic acid (HAc) and hydrochloric acid (HCl).

### Forming Coated Substrates

Steel bars or NdFeB magnets were coated with an epoxy resin composition according to embodiments described herein.

General Procedure. Depending on the procedure and conditions (shown in Table 1) for coating the substrate, one or more of the following non-limiting operations were performed to make the coated substrate the individual substrates (steel bars):
(a) The surface of the substrates were polished using sandpaper (120 grit).
(b) The surface of the substrates were degreased using dichloromethane for about 10 minutes.
(c) The surface of the substrates were treated by immersing the surface in a mixture comprising a chemical deoxidizing agent (about 3% citric acid triammonium salt in water, pH of about 7) for about 10 minutes at about 60° C., and then washed with ethanol (EtOH).
(d) The surface of the substrates were exposed to a mixture comprising a coupling agent (“coupling agent mixture” in Table 1) by immersing the surface in a coupling agent solution at a temperature of about 60° C. for about 15 minutes, followed by rinsing with 100% EtOH. Immersion in the coupling agent solution was performed less than about 30 minutes after chemical deoxidizing (operation (c)).
(e) The prepared steel bar-coupling agent was then put into a mold and then encapsulated with about 40 grams to about 50 grams of an example epoxy resin composition (Composition A or Composition B). Encapsulation with the epoxy resin composition was performed within about 30 minutes of finishing operation (d).
(f) The coated substrates were cured for about 1 hour at about 120° C. followed by another cure for about 2.7 hours at about 190° C.

Comparative Example 1: The General Procedure was not followed. Instead, the substrate was placed in a mold and then encapsulated with the epoxy resin composition.

Example 1: The General Procedure was followed without degreasing (operation (b)).

Example 2: The General Procedure was followed without degreasing (operation (b)). It was noted that the coupling agent HTM (about 10 wt %) emulsified in the methanol.

Example 3: The General Procedure was followed without degreasing (operation (b)).

Example 4: The General Procedure was followed without degreasing (operation (b)). It was noted that the L-cysteine (about 6.7 wt %) had dissolved in the deionized water.

Example 5: The General Procedure was followed without degreasing (operation (b)). It was noted that the L-cysteine (about 10 wt %) had dissolved in the deionized water solvent (with about 0.2 wt % HCl).

Example 6: The General Procedure was followed with the following changes. No degreasing (operation (b)), and after the substrate was exposed to the coupling agent (Silquest A-187), the substrate-coupling agent was dried for about 12 hours (at a temperature of about 23° C. and a relative humidity of about 50%).

Example 7: The General Procedure was followed without degreasing (operation (b)).

Example 8: The General Procedure was followed with the following changes. No degreasing (operation (b)), and the coupling agent solution was set to a temperature of about 80° C. and the time of exposure to the coupling agent solution was increased to about 30 minutes.

Example 9: The General Procedure was followed with the following changes. No degreasing (operation (b)), and the time of exposure to the coupling agent solution was shortened to about 5 minutes.

Example 10: The General Procedure was followed without degreasing (operation (b)). It was noted that the L-cysteine (about 10 wt %) and the 2EHTG (about 10 wt %) had dissolved in the ethanol (with about 10 wt % HCl).

Example 11: The General Procedure was followed.

Example 12: The General Procedure was followed. Composition B was used as the epoxy resin composition.

Example 13: The General Procedure was followed.

Example 14: The General Procedure was not followed. A NdFeB magnet was utilized as the substrate.

Example 15: The General Procedure was followed using an NdFeB magnet as the substrate.

For Examples 1-13 and C. Ex. 1 (where the substrate is a steel bar), the flexural strength of the coated substrate was tested according to the 4-point bending test as described above. For Examples 14 and 15 (where the substrate is a permanent magnet), the tensile strength was tested as described above. Non-limiting results are shown in Table 1.

TABLE 1

| | | | Coupling Agent Mixture | | | | | | |
|---|---|---|---|---|---|---|---|---|---|
| | | Chemical | Coupling | | pH | | Epoxy | Flexural | Tensile |
| | Degreasing | deoxidizing | agent | | regulator | pH | Resin | strength, | strength, |
| Ex. | (Y/N) | (Y/N) | (wt %) | Solvent | (wt %) | value | Composition | MPa | MPa |
| C. Ex. 1 | N | N | — | — | — | — | A | 16.2 | — |
| Ex. 1 | N | Y | Gabepro | Ethanol | — | 7 | A | 23.0 | — |
| | | | GPM-800 | | | | | | |
| | | | (10 wt %) | | | | | | |
| Ex. 2 | N | Y | HTM | Methanol | — | 7 | A | 32.1 | — |
| | | | (10 wt %) | | | | | | |
| Ex. 3 | N | Y | 2EHTG | Ethanol | — | 7 | A | 29.1 | — |
| | | | (10 wt %) | | | | | | |
| Ex. 4 | N | Y | L-cysteine | Deionized | — | 7 | A | 53.9 | — |
| | | | (6.7 wt %) | water | | | | | |
| Ex. 5 | N | Y | L-cysteine | Deionized | 25% HCl | 2 | A | 48.1 | — |
| | | | (10 wt %) | water | (0.2 wt %) | | | | |
| Ex. 6 | N | N | Silquest A- | Ethanol | 100% | 5 | A | 26.3 | — |
| | | | 187 | | Acetic acid | | | | |
| | | | (2 wt %) | | (0.2 wt %) | | | | |
| Ex. 7 | N | Y | L-cysteine | Deionized | — | 7 | A | 42 | — |
| | | | (13 wt %) | water | | | | | |
| Ex. 8 | N | Y | L-cysteine | Deionized | — | 7 | A | 33.6 | — |
| | | | (13 wt %) | water | | | | | |
| Ex. 9 | N | Y | L-cysteine | Deionized | — | 7 | A | 41.2 | — |
| | | | (13 wt %) | water | | | | | |
| Ex. 10 | N | Y | L-cysteine | Ethanol | 25% HCl | 2 | A | 36.3 | — |
| | | | (10 wt %) + | | (10 wt %) | | | | |
| | | | 2EHTG | | | | | | |
| | | | (10 wt %) | | | | | | |
| Ex. 11 | Y | Y | L-cysteine | Deionized | 100% | 5 | A | 82.9 | — |
| | | | (13 wt %) | water | Acetic acid | | | | |
| | | | | | (0.2 wt %) | | | | |
| Ex. 12 | Y | Y | L-cysteine | Deionized | 100% | 5 | B | 40.1 | — |
| | | | (13 wt %) | water | Acetic acid | | | | |
| | | | | | (0.2 wt %) | | | | |
| Ex. 13 | Y | Y | L-cysteine | Deionized | 100% | 5 | A | 34.2 | — |
| | | | (6.1 wt %) | water | Acetic acid | | | | |
| | | | | | (0.2 wt %) | | | | |
| Ex. 14 | Y | N | — | — | — | — | A | — | 2.38 |
| Ex. 15 | Y | Y | L-cysteine | Deionized | 35% HCl | 2 | A | — | 4.57 |
| | | | (13 wt %) | water | (0.2 wt %) | | | | |

In Table 1, “C. Ex.” refers to a comparative example and “Ex.” refers to an example of the present disclosure. In Table 1, “degreasing” refers to whether (yes or no, Y/N) the surface of the substrate was degreased. When degreasing was performed, degreasing was performed according to operation (b). “Chemical deoxidizing” refers to whether (yes or no, Y/N) the surface of the substrate was chemically deoxidized. When “chemical deoxidizing” was performed (indicated as “Y”), the chemical deoxidizing was performed according to operation (c).

The exemplary, non-limiting, data shown in Table 1 illustrates that methods described herein can significantly improve adhesion of epoxy resin compositions to substrates. Here, flexural strength is a measure of the ability of the example coated substrates (epoxy resin composition coated steel substrates to resist deformation under load). For example, when an epoxy resin composition was adhered to the steel substrate without cleaning the substrate and without using a coupling agent (C. Ex. 1), the flexural strength of the coated substrate was determined to be only 16.2 MPa. This determined flexural strength was significantly lower than all examples tested.

Moreover, even when the substrates were not degreased, the example coated substrates showed significantly higher flexural strength than the comparative example coated substrate. For example, the flexural strength of the coated substrate improved by at least about 230% (Ex. 4, about 53.9 MPa) relative to C. Ex. 1 (16.2 MPa). With degreasing, the flexural strength of the coated substrate can improve even further. For example, the flexural strength of the coated substrate of Ex. 11 was determined to be about 82.9 MPa.

The data also shows that the pH of the coupling agent mixture can affect the flexural strength of the coated substrate. For example, when the coupling agent mixture comprising about 13 wt % L-cysteine in deionized water had a pH of about 7, the flexural strength of the coated substrate was determined to be about 42 MPa (Ex. 7). When the same coupling agent mixture had a pH value of about 5 (using acetic acid), the flexural strength of the coated substrate was determined to be about 82.9 MPa (Ex. 11).

The concentration of coupling agent in the coupling agent mixture can also affect the flexural strength of the coated substrate. Here, for example, use of a lower concentration of L-cysteine (about 6.1 wt %, Ex. 13) in the coupling agent mixture resulted in a coated substrate having a flexural strength of about 34.2 MPa, while a higher concentration of L-cysteine (about 13 wt %, Ex. 11) in the coupling agent mixture resulted in a coated substrate having a flexural strength of about 82.9 MPa. That is, increased amounts of coupling agents can be utilized to improve the flexural strength of coated substrates.

Ex. 7-9 demonstrated that the temperature of the coating agent mixture, the amount of time that the substrate is exposed to the coating agent mixture, or both, can affect the flexural strength of the coated substrate. For example, the coated substrate of Ex. 8 was determined to have a flexural strength of about 33.6 MPa when the coating agent mixture was set to a temperature of about 80° C. and the exposure time of the substrate to the coating agent mixture was about 30 minutes. In contrast, when the same coating agent mixture was used—but the temperature of the coating agent mixture was set to about 60° C. and the exposure time was about 15 minutes,—the coated substrate had a flexural strength of about 42 MPa (Ex. 7). In addition, when the same coating agent mixture was used but the temperature of the coating agent mixture was set to about 60° C. and the exposure time was about 5 minutes, the coated substrate had a flexural strength of about 41.2 MPa (Ex. 9).

The examples also illustrate that various coupling agents can be utilized, including Gabepro GPM 800 (Ex. 1), 1,2,6-hexanetriyl tris(mercaptoacetate) (HTM; Ex. 2), 2-ethylhexyl thioglycolate (2EHTG; Ex. 3), Silquest A-187 (Ex. 6), and L-cysteine (Ex. 4, 5, 7-9, and 11-13). In addition, combinations of coupling agents can be used, for example, L-cysteine and 2EHTG (Ex. 10). The data indicates that use of L-cysteine as the coupling agent leads to the highest flexural strength of the coated substrate under the non-limiting conditions tested.

Further, the examples show that additives within the epoxy resin compositions (Composition A and Composition B)—such as fracture toughness improving additives (such as a polycaprolactone-polysiloxane block copolymer) synergistically combined with alcohols (such as polypropylene glycol) and inorganic fillers (such as fused silica)—can provide crack-resistant composite materials.

Examples 14 and 15 demonstrate that embodiments described herein can be used for permanent magnets. In these examples, both permanent magnet substrates were degreased. However, chemical deoxidizing and use of a coupling agent significantly improved adhesion of epoxy resin compositions to the permanent magnet. For example, the tensile strength improved by more than 90%, increasing from 2.38 MPa (Ex. 13) to about 4.57 MPa (Ex. 14).

Overall, the examples also demonstrate that epoxy resin compositions and composite materials described herein can be useful as potting materials used to stabilized rotor core designs such as those present in electric motors such as synchronous reluctance motors and PMAR motors. The examples also demonstrate that methods described herein can improve adhesion of epoxy resin compositions to substrates such as metal-containing substrates. By having this improved adhesion, the epoxy resin compositions can better support the high centrifugal forces and high thermal stresses present during operation of reluctance motors.

Embodiments of the present disclosure generally relate to epoxy resin compositions, composite materials comprising epoxy resin compositions, coated substrates comprising epoxy resin compositions, and methods of coating substrates. Embodiments described herein can be used with electric motors, such as synchronous reluctance motors and PMAR motors.

As used herein, reference to an R group, alkyl, substituted alkyl, hydrocarbyl, or substituted hydrocarbyl without specifying a particular isomer (such as butyl) expressly discloses all isomers (such as n-butyl, iso-butyl, sec-butyl, and tert-butyl). For example, reference to an R group having 4 carbon atoms expressly discloses all isomers thereof. When a compound is described herein such that a particular isomer, enantiomer or diastereomer of the compound is not specified, for example, in a formula or in a chemical name, that description is intended to include each isomer and enantiomer of the compound described individual or in any combination.

As is apparent from the foregoing general description and the specific aspects, while forms of the aspects have been illustrated and described, various modifications can be made without departing from the spirit and scope of the present disclosure. Accordingly, it is not intended that the present disclosure be limited thereby. Likewise, the term “comprising” is considered synonymous with the term “including.” Likewise whenever a composition, process operation, process operations, an element or a group of elements is preceded with the transitional phrase “comprising,” it is understood that we also contemplate the same composition or group of elements with transitional phrases “consisting essentially of,” “consisting of,” “selected from the group of consisting of,” or “Is” preceding the recitation of the composition, process operation, process operations, element, or elements and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, aspects comprising “an epoxy resin” includes aspects comprising one, two, or more epoxy resins, unless specified to the contrary or the context clearly indicates only one epoxy resin is included.

While the foregoing is directed to aspects of the present disclosure, other and further aspects of the disclosure may be devised without departing from the basic scope thereof, and the scope thereof is determined by the claims that follow.

What is claimed is:

1. An article, comprising:
a metal substrate;
a material disposed on the metal substrate, the material comprising:
a coupling agent disposed on a surface of the metal substrate; and
an epoxy resin composition disposed on the coupling agent, the epoxy resin composition comprising:
an epoxy resin;
a polyhydric alcohol;
a curing agent for curing the epoxy resin; and
a polycaprolactone-polysiloxane block copolymer.

2. The article of claim 1, wherein the coupling agent is represented by formula (IV):
R⁷—SH (IV),
wherein:
R⁷ of formula (IV) is an unsubstituted hydrocarbyl or a substituted hydrocarbyl, the unsubstituted hydrocarbyl or the substituted hydrocarbyl having from 1 to 40 carbon atoms.

3. The article of claim 2, wherein R⁷ of formula (IV) comprises 1 to 20 carbon atoms.

4. The article of claim 2, wherein the coupling agent comprises L-cysteine.

5. The article of claim 1, wherein the coupling agent is selected from the group consisting of primary thiols, secondary thiols, tertiary thiols, polythiols, mercaptan-terminated polysulfide polymers, mercaptan-terminated polyoxyalkylene derivatives, polyesters of thiocarboxylic acids, and combinations thereof.

6. The article of claim 1, wherein the metal substrate comprises a component of an electric motor.

7. The article of claim 6, wherein the component of the electric motor is selected from the group consisting of a rotor, a stator, a blade, an electric steel sheet, a grain-oriented sheet, a joint, a panel, a component thereof, and combinations thereof.

8. The article of claim 1, wherein:
the epoxy resin composition comprises a first component and a second component;
the first component comprises the epoxy resin and the polyhydric alcohol; and
the second component comprises the curing agent and the polycaprolactone-polysiloxane block copolymer.

9. The article of claim 8, wherein:
when the curing agent comprises an anhydride curing agent, the epoxy resin composition comprises about 70 parts to about 100 parts by weight of the second component per 100 parts by weight of the first component; or
when the curing agent comprises an amine curing agent, the epoxy resin composition comprises about 10 parts to about 30 parts by weight of the second component per 100 parts by weight of the first component.

10. The article of claim 8, wherein:
the first component comprises:
from about 75 wt % to about 99.5 wt % of the epoxy resin based on a total weight of the first component; and
from about 0.5 wt % to about 25 wt % of the polyhydric alcohol based on the total weight of the first component, the total weight of the first component not to exceed 100 wt %; and
the second component comprises:
from about 80 wt % to about 99 wt % of the curing agent based on a total weight of the second component; and
from about 1 wt % to about 20 wt % of the polycaprolactone-polysiloxane block copolymer based on the total weight of the second component, the total weight of the second component not to exceed 100 wt %.

11. The article of claim 1, wherein the material is a cured product of the coupling agent and the epoxy resin composition, and wherein the cured product comprises a composite material.

12. The article of claim 1, wherein:
the epoxy resin is derived from a compound selected from the group consisting of bisphenol A, bisphenol F, tetraglycidyl-methylenedianiline, a terephthalic acid, phthalic acid, hexahydrophthalic acid, halogenated bisphenol, novolac, ortho-aminophenol, para-aminophenol, flourenone bisphenol, dicyclopentadiene, and combinations thereof,
the polyhydric alcohol is selected from the group consisting of ethylene glycol, propylene glycol, polyethylene glycol, polypropylene glycol; or
combinations thereof.

13. An electric motor component, comprising:
a metal substrate; and
a composite material disposed on the metal substrate, the composite material comprising a reaction product of:
a coupling agent; and
an epoxy resin composition comprising:
an epoxy resin;
a polyhydric alcohol;
a curing agent for curing the epoxy resin; and
a polycaprolactone-polysiloxane block copolymer.

14. The electric motor component of claim 13, wherein the coupling agent is selected from the group consisting of a sulfur-containing species, a nitrogen-containing species, a silicon-containing species, and combinations thereof.

15. The electric motor component of claim 13, wherein the metal substrate comprises aluminum, aluminum alloy, nickel, iron, iron alloy, steel, electric steel, titanium, titanium alloy, copper, copper alloy, and mixtures thereof.

16. A method of coating a component of an electric motor, comprising:
introducing a coupling agent with a surface of a component of an electric motor;
depositing an epoxy resin composition on the coupling agent; and
curing the coupling agent and the epoxy resin composition to form a composite material disposed on the surface of the component of the electric motor, the composite material comprising the coupling agent, the epoxy resin composition, a reaction product thereof, or combinations thereof.

17. The method of claim 16, wherein the introducing the coupling agent with the surface of the component of the electric motor comprises:
introducing a mixture comprising the coupling agent and a solvent to the surface of the component of the electric motor, the mixture having:
a temperature that is from about 40° C. to about 90° C.; and
a pH of about 7.5 or less.

18. The method of claim 16, wherein:
the coupling agent is selected from the group consisting of a sulfur-containing species, a nitrogen-containing species, a silicon-containing species, and combinations thereof.

19. The method of claim 16, further comprising:
performing a pre-treatment prior to exposing the surface of the component of the electric motor to the coupling agent, the pre-treatment comprising cleaning the surface of the component of the electric motor by degreasing, alkaline washing, chemical etching, chemically deoxidizing, mechanically deoxidizing, or combinations thereof.

20. The method of claim 19, wherein:
the pre-treatment comprises degreasing;
when the pre-treatment comprises the chemically deoxidizing the surface of the component of the electric motor, the chemically deoxidizing comprises exposing the surface of the component of the electric motor to a chemical deoxidizing agent comprising citric acid triammonium salt, phosphoric acid, hydrochloric acid, an ion thereof, or combinations thereof, or
combinations thereof.
